(19) United States
(12) Patent Application Publication
(10) Pub. No.: US 2023/0420754 A1
(43) Pub. Date: Dec. 28, 2023

(54) METHODS AND DEVICES FOR AVOIDING DAMAGE TO BATTERIES DURING FAST CHARGING

(71) Applicant: Omnitek Partners LLC, Ronkonkoma, NY (US)

(72) Inventor: Jahangir S. Rastegar, Stony Brook, NY (US)

(73) Assignee: Omnitek Partners LLC, Ronkonkoma, NY (US)

(21) Appl. No.: 18/244,275

(22) Filed: Sep. 10, 2023

Related U.S. Application Data
(63) Continuation-in-part of application No. 18/125,099, filed on Mar. 22, 2023.
(60) Provisional application No. 63/526,467, filed on Jul. 13, 2023.
(60) Provisional application No. 63/322,524, filed on Mar. 22, 2022.
(60) Provisional application No. 63/429,994, filed on Dec. 3, 2022.

(51) Int. Cl. H01M 10/44

(52) U.S. Cl. CPC H01M 10/443; H01M 10/446; B60L 53/11

(57) ABSTRACT

A charging heating device for charging and temperature maintenance of an energy storage device having a core with an electrolyte, with one input having characteristics of a frequency-dependent resistor and inductor series coupled to a voltage source, the device including: a coupling coupled to the one input; an exciter coupled to the coupling, the exciter provides a positive and negative input current at the one input, the exciter operates a heating mode where a current frequency is set at or close to a maximum heating rate to internally heat the electrolyte, and an ionic-excitation mode where the current frequency is set above the maximum heating rate to generate ionic-excitation of the electrolyte ions; an input coupled to a charger; a switch coupling the device input and the coupling; and a controller controlling the exciter and switching of the modes.

### CROSS REFERENCE TO RELATED APPLICATIONS

This application claims priority to U.S. Provisional Application 63/526,467, filed on Jul. 13, 2023, the entire contents of which is incorporated here by reference, which is a continuation-in-part of U.S. patent application Ser. No. 18/125,099 filed on Mar. 22, 2023, which claims the benefit of U.S. Provisional application No. 63/322,524, filed on Mar. 22, 2022 and 63/429,994, filed on Dec. 3, 2022, the entire contents of each of which are incorporated here by reference.

### BACKGROUND

### Field

This disclosure is directed to methods and devices for fast charging batteries and more particularly to methods and devices for fast charging batteries at high DC currents while avoiding damage to the battery. At low temperatures, the battery electrolyte may be heated directly before rapid charging. The methods and devices are applicable to primary and secondary batteries, such as Lithium-ion, Lithium-polymer, NiMH and lead-acid batteries and are also applicable to super-capacitors.

### Prior Art

The performance of batteries and super-capacitors is significantly reduced at low temperatures. This is the case for both primary and rechargeable batteries. In addition, current lithium-ion and Lithium-polymer battery technology does not allow battery charging at temperatures below zero degrees C. and charging at temperatures below their optimal level has been shown to reduce battery life.

Current solutions that try to address cold weather effects on batteries include heating the exterior of the battery by integrating “heaters” into the battery compartment or using heating blankets, or recently by embedding heating elements inside the batteries.

It is also well known that even at their optimal performance temperature, usually around room temperature, if the battery is charged at high rates, i.e., the so-called “fast charging”, does also similarly damage batteries and reduces the battery life. This is particularly the case in lithium-ion, Lithium-polymer, and other similar batteries that are used or are planned to be used in various vehicles and other mobile platforms as well as for large energy storage applications. Fast charging, particularly at 2C-3C rates and higher, of such batteries is very important since it is one of the main challenges in many applications, such as in electric vehicles and trucks and other electric powered platforms. It is appreciated that fast charging at 2C-3C or higher is desired to be without damage to the battery and reduction in its life, i.e., the so-called cycle time.

### SUMMARY

Methods and devices for direct and rapid heating of battery electrolyte at low temperatures and maintaining the battery temperature at its optimal performance level are disclosed. The technology has been extensively tested on a wide range of primary and secondary batteries at temperatures as low as −54° C. without causing any damage to the batteries. The technology is applicable to almost all primary and secondary batteries, such as Lithium-ion, Lithium-polymer, NiMH and lead-acid batteries. The technology is also applicable to super-capacitors and has been used to rapidly heat super-capacitors at temperatures as low as −54° C. without any damage.

The methods and devices are based on direct heating of the battery electrolyte using appropriately formed high frequency AC currents. The methods and devices take advantage of the electrical characteristics of the batteries and super-capacitors to heat the electrolyte directly and very rapidly to its optimal operating temperature without causing any damage.

The developed electrolyte heating units are externally powered at extremely low temperatures at which the battery is unable to provide a significant amount of power. Once the battery can provide enough power, the battery temperature may be raised to its optimal level and maintained at that level by power from the battery itself. The battery may be fully charged or discharged.

The developed electrolyte heating units are inherently highly efficient and safe and can be readily integrated into the battery safety and protection circuitry and battery chargers.

The following are some of the main characteristics of the disclosed methods and devices:
It requires no modification to the battery and super-capacitor.
The basic physics of the process and extensive tests clearly show no damage to the battery and super-capacitor.
The battery pack protection electronic units, such as those for Lithium-ion and Lithium-polymer batteries, can be modified to ensure continuous high-performance operation at low temperatures.
The battery electrolyte and super-capacitor is directly and uniformly heated, therefore bringing a very cold battery to its optimal operating temperature very rapidly and minimizing heat loss from the battery.
Direct electrolyte heating requires significantly less electrical energy than external heating such as with the use of heating blankets.
Standard sized Li-ion or Li-polymer batteries can be used instead of thin and flat battery stack packaging to accelerate external heating via heating blankets or the like.
The technology is simple to implement and low-cost.

The configuration and operation of the electrolyte heating units are described herein in detail and sample heating curves from −54° C. to 20° C. for Li-ion, Li-polymer and lead-acid batteries are presented and discussed.

It is appreciated that currently, one of the main challenges of using rechargeable batteries, such as Lithium-ion, Lithium-polymer, and other similar rechargeable batteries is the amount of relatively long time that it takes to fully charge them. This is particularly the case in Electric Vehicle (EV) and other electrically powered mobile platforms, such as trucks, lift-trucks, cranes, and the like platforms.

It is, therefore, highly desirable to have methods and devices that could be used to charge batteries, such as Lithium-ion, Lithium-polymer, and other similar rechargeable batteries, at significantly higher rates that are currently available and are generally below 1C rate, so that the batteries could be charged significantly faster that is currently possible without damaging the battery and significantly reducing their life cycle. Such battery “fast charging” capabilities would address one of the main challenges facing EV and electric truck, and other electric platform applications.

There is therefore a need for methods and devices for fast charging rechargeable batteries, i.e., charging them at rates that of over 2C-3C and even higher, without causing more damage than is currently limiting the life cycle of such batteries.

It would also be highly desirable if the developed “fast Charging” battery chargers to be provided with “fast charging” capability at low temperatures.

A need, therefore, exists for methods and systems for fast charging rechargeable batteries, such as Li-ion, Li-polymer, the so-called solid-state batteries, and the like, at rates of 2C-3C and higher, even up to 4C-6C, without causing damage to the battery and reducing its life and cycle life.

Accordingly, methods and systems are provided that can be used to charge rechargeable batteries, such as Li-ion, Li-polymer, the so-called solid-state batteries at rates that may exceed 2C-3C, without causing damage to the battery and reducing its life and cycle life.

It is appreciated that a very large number of battery chargers already exists and are being used to charge various rechargeable batteries, including Li-ion, which could be converted to fast-chargers without requiring any changes in the charger and in the devices and platforms, such as electric vehicles, trucks, lift-trucks, construction, material handling equipment, and the like, that would be using the fast-charger. It is therefore highly desirable to develop methods to “convert” existing battery chargers to “fast-chargers” capable of charging batteries at high rates, such as at rates that are at or over 2C-3C.

A need therefore exists for methods and systems that can “convert” existing battery chargers to “fast chargers” without requiring any changes in the charger and in the devices and platforms, such as electric vehicles, trucks, lift-trucks, construction, material handling equipment, and the like, that would be using the resulting fast-chargers.

Accordingly, methods and systems are provided that can be used to “convert” existing battery chargers to “fast chargers” without requiring any changes in the charger and in the devices and platforms, such as electric vehicles, trucks, lift-trucks, construction, material handling equipment, and the like, that would be using the resulting fast-chargers.

It is appreciated that in certain applications, such as in electric vehicles, trucks, various mobile platforms, and the like, it is highly desirable to have the disclosed high-frequency direct battery electrolyte heating capability incorporated into these platforms so that their batteries could be charged at any desired rate, including fast rates, using the available chargers.

A need therefore exists for methods and systems to incorporate the disclosed high-frequency direct battery electrolyte heating capability into various fixed or mobile platforms and devices, such as electric vehicles, trucks, various mobile platforms, and the like.

Accordingly, methods and systems are provided that can be used incorporate the disclosed high-frequency direct battery electrolyte heating capability into various fixed or mobile platforms and devices, such as electric vehicles, trucks, various mobile platforms, and the like.

### BRIEF DESCRIPTION OF THE DRAWINGS

FIG. 1 illustrates the plot of relative capacity of commercial 18650 Li-ion batteries as a function of temperature.

FIG. 2 illustrates the plot of State of Health (SOH) of 18650 Li-ion batteries vs. number of cycles as a function of operating temperature.

FIG. 3 illustrates the liquid-solid phase diagram of EMC-EC. The closed dots represent measured data for three different solutions of LiPF6 in an EMC-EC solvent.

FIG. 4 illustrates an equivalent (lumped) circuit model of a battery that is subjected to a high-frequency AC current.

FIG. 5 illustrates an equivalent circuit model of a battery for high frequency heating at a given battery temperature.

FIG. 6: Illustrates the plot of the amplitude of the applied test AC voltage at the battery terminals as a function of frequency.

FIG. 7: Illustrates the plot of the amplitude of the applied test AC current at the battery terminals as a function of frequency.

FIG. 8 illustrates the plot of the amplitude ration of the voltage and current as a function of frequency.

FIG. 9 illustrates the plot of the phase angle (leading) between the voltage and current waveforms of FIGS. 6 and 7, respectively.

FIG. 10 illustrates the plot of heating rate at room temperature for the tested CR123A Li-ion battery as a function of heating current frequency with a fixed RMS current of 4 A.

FIG. 11 illustrates the plot of heating curves for the CR123 Li-ion battery by externally supplied power at 80 KHz at various AC current amplitudes.

FIG. 12 illustrates the plot of heating rate of the CR123 Li-ion battery with 80 kHz current of different amplitudes as measured and as predicted by the developed model, equation (11).

FIG. 13 illustrates the block diagram of a high-frequency current battery heating device that is powered by an external power source.

FIG. 13A illustrates the schematic of the high-frequency current battery heating circuit of the device of FIG. 13, which is powered by an external power source.

FIG. 14 illustrates the schematic of a high-frequency current battery heating circuit that is powered by the battery power for self-heating.

FIG. 15 illustrates the plot of high-frequency heating rate curves for a Li-ion CR123 battery from several low temperatures to room temperature using externally provided power source to power the heating circuit.

FIG. 16 illustrates the plot of the temperature of a Li-ion CR123 battery being self-heated in an extreme cold environment of −60° C. The plot of a companion Li-ion CR123 battery that is not heated is also provided.

FIG. 17 illustrates the plot of the temperature of a large Lead-acid battery as its temperature is maintained within a specified range with the high-frequency AC current battery electrolyte heating system of FIGS. 13A and 13B.

FIG. 18 illustrates the heating rate for a 12 V Type 29HM lead acid battery at room temperature with externally powered high-frequency AC current as a function of current frequency and applied current.

FIG. 19 illustrates a graph showing battery voltage as a function of frequency with battery current held constant at 20 A.

FIG. 20 illustrates a graph showing battery current as a function of frequency with battery voltage held constant at 50 mV.

FIG. 21 illustrates a graph showing battery frequency response.

FIG. 22 illustrates a graph showing measured heating rates for the Die Hard 12 V lead acid battery at constant currents.

FIG. 23 illustrates a Li-ion battery electrolyte AC voltage heating test set-up.

FIG. 24 illustrates a graph showing Plots of electrolyte heating of an 18650 Li-ion battery cell as measured by the battery surface temperature as a function of time.

FIG. 25 illustrates a block diagram of the rapid battery charging and high-frequency current battery electrolyte heating device system (“Fast-Charger System”) that is powered by an external power source for use to charge batteries at a prescribed rate, including at very high-rates and in cold temperatures.

FIG. 25A illustrates a block diagram of a fully “Integrated Battery Heater and Charger” shown in FIG. 25 with high-frequency current battery electrolyte heating device system (“Fast-Charger System”) that is powered by an external power source for use to charge batteries at a prescribed rate, including at very high-rates and in cold temperatures.

FIG. 26 illustrates a block diagram of a rapid battery charging and high-frequency current battery electrolyte heating device system (“Fast-Charger System”) that is powered by an external power source and constructed with an existing battery charger unit.

FIG. 27 illustrates a block diagram of the rapid battery charging and high-frequency current battery electrolyte heating device system (“Fast-Charger System”) that uses an adaptor to connect an available “Battery Charger” and a “Battery Heater/Ionic Exciter”, both externally powered, to the battery via provided connectors.

FIG. 28 illustrates a block diagram of a rapid battery charging and high-frequency current battery electrolyte heating device system (“Fast-Charger System”) with its “Battery Heater/Ionic Exciter” and related component having been incorporated into the electrically powered platform, which is then connected to an external charger for charging the platform battery.

FIG. 29 illustrates a block diagram of a modified “Platform Integrated Fast-Charging System” embodiment of FIG. 28 for providing battery self-powered heating when the battery charger is not connected to the platform and when it is not turned on to charge the battery.

### DETAILED DESCRIPTION

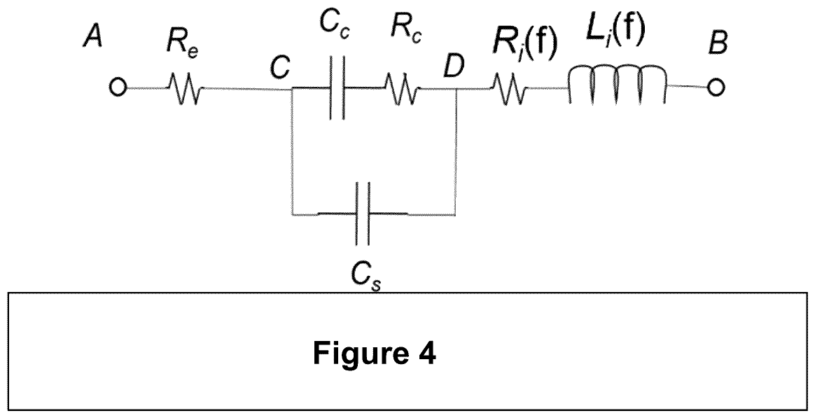

To describe the developed direct battery electrolyte heating technology, consider a Lithium-ion battery. The basic operation of the battery may be approximately modeled with the equivalent (lumped) circuitry shown in FIG. 4.

In this model, the resistor Rₑ is considered to be the electrical resistance against electrons from freely moving in conductive materials with which the electrodes and wiring are fabricated. The equivalent resistor R and Li represent the resistance to free movement of Lithium ions by the battery electrolyte and equivalent inductance of the same, respectively. The capacitor G is the surface capacitance, which can store electric field energy between electrodes, acting like parallel plates of capacitors. The resistor R_{c} and capacitor C_{c} represent the electrical-chemical mechanism of the battery in which C_{c} is intended to indicate the electrical energy that is stored as chemical energy during the battery charging and that can be discharged back as electrical energy during the battery discharging, and R_{c} indicates the equivalent resistance in which part of the discharging electrical energy is consumed (lost) and essentially converted to heat. The terminals A and B indicate the terminals of the Lithium-ion battery.

In the Li-ion model of FIG. 4, the components R, R_{c} and C_{c}, are highly sensitive to temperature. At low temperature, the resistance of the resistor R increases due to the increase in the “viscous” resistance of the electrolyte to the movement of lithium ions. This increase in resistance causes higher losses during charging and discharging of the Li-ion battery. Low temperature charging passes (relatively high) currents through the indicated components R_{c} and C_{c} and it is well known that such low temperature charging results in so-called lithium plating, which is essentially irreversible, prevents battery charging and permanently damages the battery.

The operation of the Li-ion battery, as modeled in FIG. 4, may then be described as follows. If an AC current with high enough frequency is applied to the battery, due to the low impedance of the capacitor Cₛ, there will be no significant voltage drop across the capacitor, i.e., between the junctions C and D, and the circuit effectively behaves as if the capacitor Cₛ, were shorted. As a result, the applied high frequency AC current essentially passes through the resistors Rₑ and Rᵢ and inductor Lᵢ and not through the R_{c} and C_{c} branch to damage the electrical-chemical components of the battery. Any residual current passing through the R, and C_{c} branch would also not damage the battery due to its high frequency and zero DC component of the applied current. The high frequency AC current passing through the resistors Rₑ and R and inductor L will then heat the battery core, thereby increasing its temperature. If the high frequency AC current is applied for a long enough period, the battery core temperature will rise enough to make it safe to charge using the commonly used DC current charging methods.

It is appreciated that inductance Lᵢ in the model of FIG. 4 can only be assumed to be constant at relatively low passing AC current frequencies. This is the case since for a given AC current level, as the frequency of the passing current increases, the increase in the speed of the ionic “oscillatory” motions in the battery electrolyte would increase the heat loss across the modeled inductance Lᵢ in FIG. 4. This has been shown to be the case for Li-ion and lead-acid battery experiments, the results of one such experiment with a lead-acid battery is provided below.

In this experiment, a lead-acid battery voltage and current characteristics were measured over a frequency span range from 1 kHz to 70 kHz.

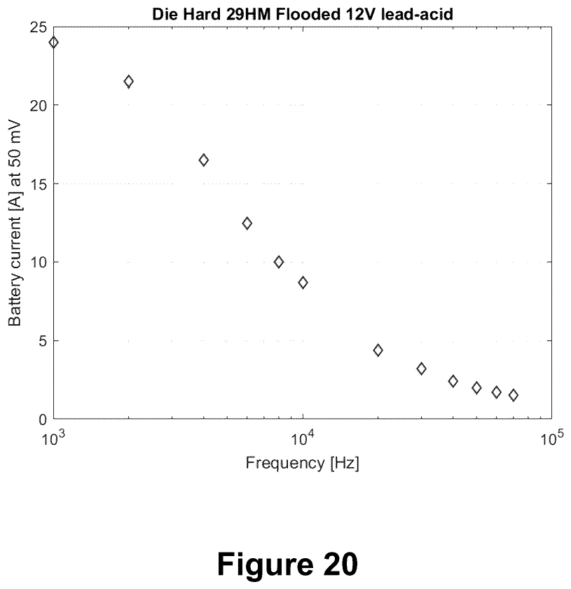

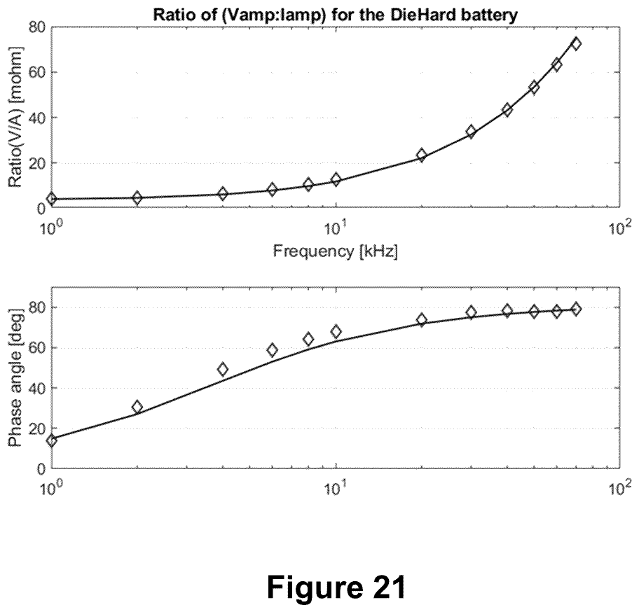

A 12 V flooded lead acid battery (Die Hard model #29-HM, m=27.1 kg and capacity=65 Ah) was used in this experiment. FIG. 19 shows the voltage response of the battery as a function of frequency at a constant current of 20 A and FIG. 20 is the current response at a constant voltage of 50 mV. In FIG. 20, the indicated voltage is its increase about the battery voltage of 12 V. Both current and voltage are measured at the battery terminals.

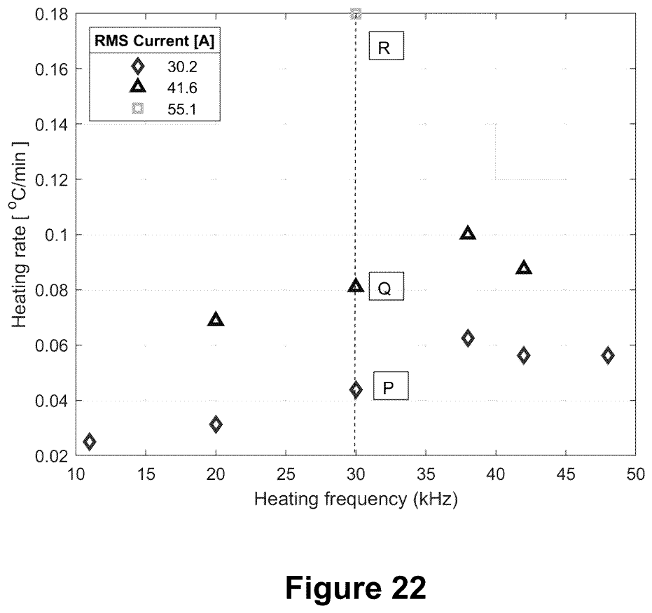

The measured voltage and current data of FIGS. 19 and 20 were then used to extract the amplitude ratio of the voltage and current and the phase angle (leading) between the measured voltage and current waveforms. The response obtained from both data sets (voltage vs. frequency and current vs. frequency) were identical and the plots from the constant voltage test are shown in FIG. 21.

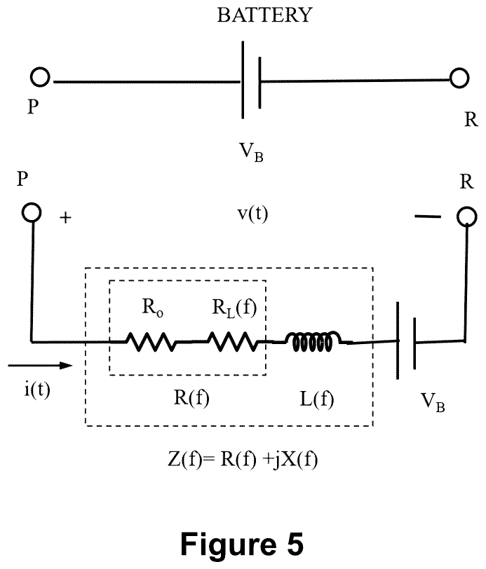

As can be seen in the plots of FIG. 21, as the frequency is increased, the phase shift is increased and approaches 90 degrees, which means that the battery is exhibiting the characteristics of an “inductive” element. However, as it is shown later in this section, when an AC current with a constant amplitude is applied to the battery, as the current frequency is increased, the amount of heat that is generated inside the battery is increased. This indicates that if we want to develop a model to represent the battery heating process due to high frequency current, the first order approximation of such a model should look as shown in the diagram of FIG. 5. It should be noted that terms such as “resistance” and “inductance” are borrowed from the electric circuit terminology for convenience.

In the model of FIG. 5, R₀ is the resistance component that is constant (possibly mostly due to the conductive components of the battery) and R_{L}(f) is the frequency dependent resistance component of the battery, which is due to the oscillatory motion of the ions inside the battery electrolyte. The frequency dependent resistance R_{L}(f) is therefore expected (and verified as shown later) to increase with frequency up to a certain frequency and begin to drop with further increase in the frequency.

Borrowing the terms “resistance” and “inductance” from the electric circuit terminology, the model of FIG. 5 includes a non-frequency dependent “resistor” R₀, and a frequency dependent “inductor” and a frequency dependent “resistor”. The battery “impedance” Z(f) is therefore given by

Z(f)=R(f)+jX(f) (1)

Using the first order approximation, R(f) and X(f) can be expressed as,

R(f)=[R₀+P₁f] and X(f)=P₂f (2)

where f is the frequency in Hz, R₀ is the resistance in mΩ, and P₁ and P₂ are constant coefficients with units [mΩ/Hz] and [mΩ/Hz], respectively, which are to be determined by fitting the data provided by the plots of FIG. 21. For the present battery, the resistance R₀ was measured to be R₀=3.8 mΩ using the DC step method.

Referring to FIG. 5, the voltage v(t) and the current i(t) at the battery terminals are given by

v(t)=Vₒ cos(2πft+θᵥ) and i(t)=Iₒ cos(2πft+θᵢ) (3)

where Vₒ and θᵥ are the amplitude and phase angle of the voltage and Iₒ and θᵥ are the amplitude and phase angle of the current waves, respectively. The DC voltage term corresponding to the battery voltage is excluded from the equation. Using phasor notation, the battery “impedance” Z(f) is expressed in terms of its magnitude and phase as

$$\vert Z ( f ) \vert = \sqrt{{R}^{2} ( f ) + {X}^{2} ( f )} = \sqrt{{( 3.8 + {P}_{1} f )}^{2} + {( {P}_{2} f )}^{2}} \qquad ( 4 )$$

$$Δ f [ deg ] = \frac{180}{π} {tan}^{- 1} [ \frac{X ( f )}{R ( f )} ] = \frac{180}{π} {tan}^{- 1} [ \frac{{P}_{2} f}{( 3.8 + {P}_{1} f )} ] \qquad ( 5 )$$

Either equation (4) or equation (5) can be used to obtain the unknown coefficients Pi and P₂, for example, through a non-linear least squares curve fitting technique. Using equation (5) for fitting to the phase data in FIG. 21, the unknown coefficients are calculated as P₁=0.155×10⁻³ mΩ/Hz and P₂=1.05×10⁻³ mΩ/Hz. The solid line shows the fit obtained. These recovered parameters P₁ and P₂ were used to obtain the solid line in the (V/I) ratio (i.e., |Z(f)|) plot of FIG. 21.

During heating, the RMS current I, flowing through the frequency dependent “resistor” R(f) of the battery generates heat due to the absorbed power I²R(f). The absorbed power, indicated as P(f, I), can then be expressed as

P(f,I)=I²R(f)=I²[3.8+P₁f]×10⁻³[W] (6)

where R(f)=(R₀+P₁ f) and R₀=3.8×10⁻³ Ohm.

This absorbed power raises the temperature of the battery based on its mass m (kg), specific heat capacity Cₚ (J.kg⁻¹.° C.⁻¹) and duration t(s). The increase in temperature DT (° C.) is given by

$$Δ T = \frac{P ( f , I ) t}{{C}_{p} m} \qquad ( 7 )$$

Now defining β as expressed in equation (8) and replacing the above values for m and Cₚ for the present battery, we get

$$β = \frac{m {C}_{p}}{60} = \frac{( 27.1 kg ) ( 727.1 {Jkg}^{- 1} . ° {C}^{- 1} . )}{60} = 328.5 W / ( ° C {.}^{- 1} / min ) \qquad ( 8 )$$

The heating rate HR (° C./min) is then obtained by dividing equation (7) by time (which is now in minutes) and using β as expressed in equation (8) to get

$$HR ( f , I ) = \frac{Δ T}{t} = \frac{1}{β} {I}^{2} [ {R}_{0} + {P}_{1} f ] [ ° C . / min ] \qquad ( 9 )$$

Now substituting the values of R₀, P₁ and β into equation (9), the heating rate for the tested battery becomes

HR(f,I)=30.04×10⁻⁶[3.8+0.155×10⁻³f]I²[° C./min] (10)

where f is in Hz and I is the rms current in A.

It should be noted that the heating model expressed in equation (10) is derived from the battery characterization using sinusoidal current and voltage waveforms.

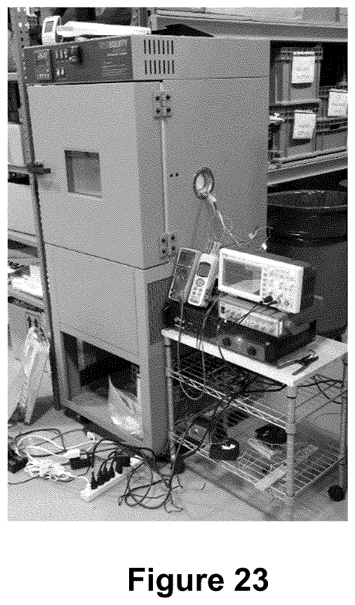

To verify the high frequency heating model shown in FIG. 5 and the derived heating rate equation (10), heating measurements were performed on the 12 V flooded lead acid battery using the high frequency heating system that applies a prescribed AC current with a selected frequency. Measurements were performed on the uninsulated battery at room temperature. At constant heating currents, the internal temperature of the battery (monitored by a thermocouple mounted in the electrolyte) was recorded over a time duration of 10 mins to 16 mins. The heating rate HR (° C./min) was obtained from the temperature difference at the start and end of the test. FIG. 22 shows the plot of the heating rate as a function of frequency for the indicated AC currents.

The equation (10) is then used to calculate the heating rates at the currents of points P, Q and R, FIG. 5, i.e., at 30.2, 41.6 and 55.1 A, respectively, and compare the results with the measured values at those points.

At point P, FIG. 22, the measured heating rate is 0.044° C./min with 1=30.2 A and f=30 kHz. From equation (10) and including the required scaling factor of V (for the triangular shaped applied current at frequencies above 10 KHz), the heating rate is calculated to be 0.041° C./min as shown below.

HR(f,I)=×3.04×10⁻⁶[3.8+0.155×10⁻³f](30.2)²=0.041[° C./min]

The measured heating rates at points Q and R in FIG. 22 are 0.10° C./min with 1=41.6 A and 0.18° C./min with 1=55.1 A, respectively, at the current frequency of f=30 kHz. The corresponding calculated heating rates were then similarly obtained using equation (10) as 0.08° C./min and 0.14° C./min at points Q and R, respectively.

Considering the limitations of the above tests, the results clearly confirm the validity of the high frequency battery heating model of FIG. 5 and validate the use of high frequency currents to heat the battery from the inside. Within the range of currents used in the tests (30 A to 55 A); equation (10) is a good predicator of the heating rate for the flooded lead acid battery.

As an example of the presented high frequency heating method to Li-ion batteries, a single 18650 Li-ion battery cell was heated from different low temperatures to 20° C. using a high frequency AC heating circuitry.

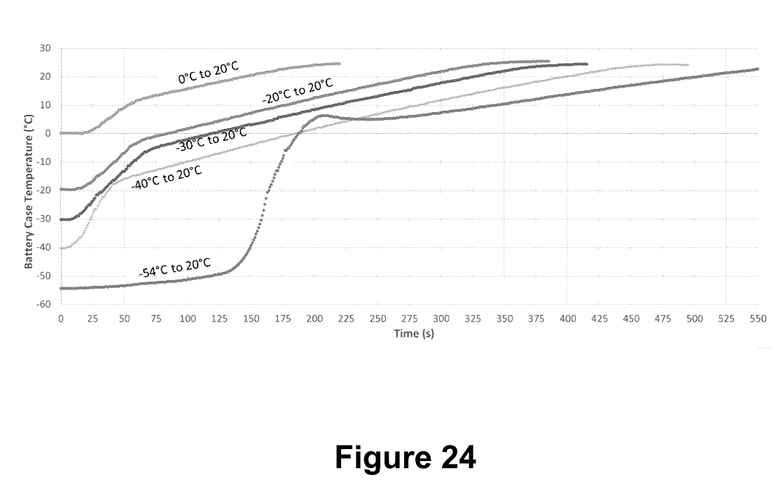

The battery was wrapped in a layer of 0.25″ thick ceramic Fiberfrax insulation and kept in an environmental chamber, which was kept at the selected low temperature level during the test. Two thermocouples were used to measure the surface temperature of the battery during the test. The test set-up is shown in FIG. 23. The peak AC heating current was kept at 14 A and at a frequency of 10 KHz. It is noted that even the AC voltage of the high frequency signal used for heating the electrolyte can be significantly higher than the rated voltage of the battery.

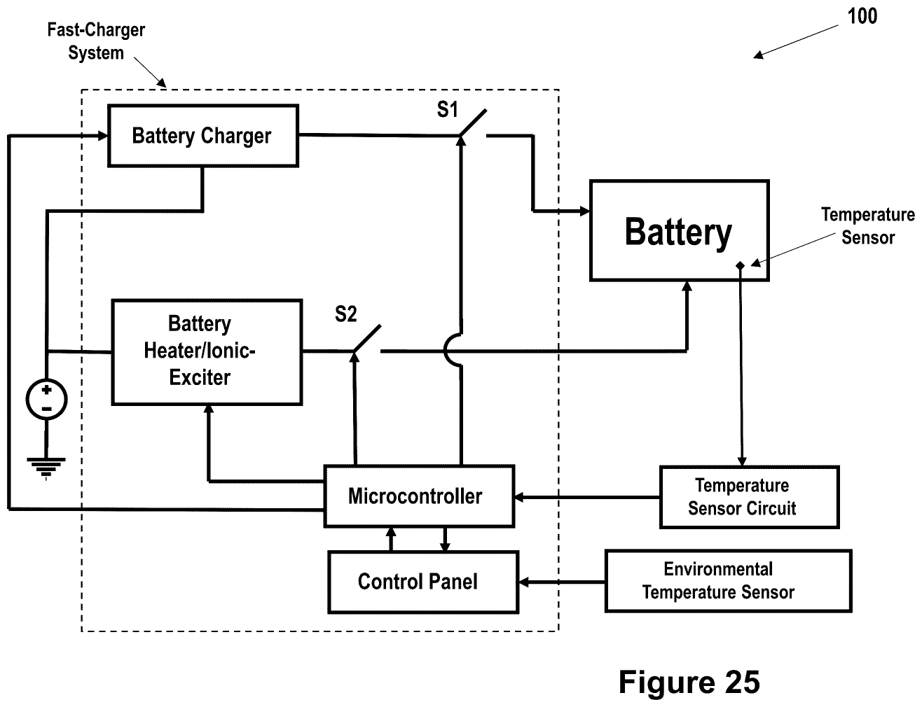

The plots of electrolyte heating as measured by the battery surface temperature as a function of time are shown in FIG. 24.

The methods and devices for direct and rapid heating of battery electrolyte at low temperatures and maintaining the battery temperature at its optimal performance level has been extensively tested on a wide range of primary and secondary batteries at temperatures as low as −54 deg. C without causing any damage to the batteries. The technology is applicable to almost all primary and secondary batteries, such as Lithium-ion, Lithium-polymer, NiMH and lead-acid batteries. The technology is also applicable to super-capacitors and has been used to rapidly heat super-capacitors at temperatures as low as −54 deg. C without any damage.

The technology is based primarily on the identified frequency dependence of the response of batteries to AC current. Based on the findings of the above studies, a more representative model of batteries that are subjected to high frequency current has been developed and validated experimentally. Similar tests that are presented for a lead-acid battery has also been performed on Li-ion batteries with similar results, confirming that the source of the frequency dependent “resistance” shown in the developed model should be the ionic oscillatory motion in the electrolyte.

The present highly innovative high-frequency AC current direct electrolyte heating technology is based on in-depth studies that were carried by the inventor of the highly nonlinear dynamic behavior of the battery electrolyte components when subjected to a high-frequency electric field, which results in generation of heat in the battery electrolyte. Based on the results of these studies, a model is developed that describes battery electrolyte heating rate, i.e., the high-frequency direct heating of a battery electrolyte, as a function of the electrolyte temperature, AC current (RMS) magnitude, and frequency. The model is also applicable to high-frequency AC current heating of supercapacitors. It is noted that the applied AC current of the is generally desired to be symmetric, i.e., have no or negligible DC component.

In the present direct electrolyte heating technology, the applied high-frequency AC currents are generally in the range of 50-120 KHz for Lithium-ion and Lithium-Polymer and KHz for Lead-Acid batteries, similarly high for other rechargeable and primary batteries, including thermal reserve and liquid reserve batteries, and 1-2 MHz for super-capacitors.

It is appreciated by those skilled in the art that the use of AC heating signals of up to around 1 KHz has been referred to as “high-frequency” in some battery heating discussions found in the published literature. In the present direct electrolyte heating technology, the term “high-frequency” refers to frequencies that are well above frequencies (around 1 KHz) that have been used and analyzed using linear electrical models to determine the maximum resistive battery heating rates. Historically, there has been considerable interest in the electrical properties of batteries around 1 kHz. Around this range of frequencies, the battery appears inductive above and capacitive below some resonance frequency. These frequency dependent effects are characterized by the modified Randles equivalent battery circuit model (see for example: Randles, J. E. B. (1947). “Kinetics of rapid electrode reactions”. Discussions of the Faraday Society. 1: 11. doi:10.1039/df9470100011. ISSN 0366-9033, and A. Lasia, A., Electrochemical impedance spectroscopy and its applications. In: Modern Aspects of Electrochemistry. Volume 32. Kluwer Academic/Plenum Pub. 1999, Ch.2, p. 143), which is valid for frequencies of up to around 1 kHz. The model is not valid at higher frequencies used in the present technology since it does not include the components related to the highly nonlinear dynamic behavior of the battery electrolyte, which is related to the highly nonlinear dynamic behavior of ionic oscillatory motions in the battery electrolyte. As it is described later in this disclosure, the high-frequency ionic oscillatory motion inside the battery electrolyte results in a high rate of the battery electrolyte heating, which at a given temperature and AC current level, increases with frequency to a peak level and begins to drop with increased frequency. At these high AC current frequencies, the heating rate is shown to be nearly proportional to the square of the applied RMS current.

As an example, in the disclosed direct electrolyte heating technology, at room temperature, the applied high-frequency AC currents are in the range of 50-120 KHz for Lithium-ion and Lithium-Polymer and 10-50 KHz for Lead-Acid batteries, and 1-2 MHz for super-capacitors.

It is also appreciated by those skilled in the art that the aforementioned commonly used linear electric circuit battery models would indicate negligible and close to zero net battery heating power at frequencies above around 1 KHz due to close to the resulting around 90 degrees phase shift between the applied current and voltage that such models would indicate.

It is also appreciated by those skilled in the art that some heating is inevitable due to low frequency (up to around the resonant frequency of around 1-2 KHz for most rechargeable batterie) and DC current flow through the internal resistance indicated by the aforementioned linear battery circuit models during charging and discharging as with the application of the so-called “mutual pulse heating”. The resultant heating processes due to such current flows are unavoidable, but their magnitudes are minimal as compared to the present high-frequency AC current heating, since batteries are designed to exhibit minimal internal resistance, particularly for use in cold environments.

The high-frequency electrolyte heating technology heats the battery electrolyte directly and uniformly with the least amount of electrical energy as compared to other currently available technologies, i.e., by external heating pads or blankets or the so-called “mutual pulse heating”, and by the provision of internal heating elements. The heating pads and blankets consume the most amount of energy since they must heat the entire battery mass, while overcoming heat loss from their outer surfaces. The heating pads and blankets are also thermodynamically inefficient as well as consuming the most amount of energy since they must heat the entire battery mass, while overcoming heat loss from their outer surfaces. The heating process is also slow since heat must be conducted into the battery core. The internally provided electrical heating members consume less energy than heating pads and blanket, but are relatively slow, since they also rely on heat conduction, and at very low temperatures, they require higher current rates, which could damage the battery due to hot spots. Batteries with internal heating members are more costly to produce and do not currently have enough market for large volume production.

The disclosed high-frequency AC current direct battery electrolyte heating technology may use either an external source of power or the battery's internal power to rapidly bring the electrolyte temperature to its optimal temperature and to maintain that temperature for the best possible battery charging and discharging performance and its cycle life. For instance, by operating Li-ion batteries within their optimal temperature range of 20-30° C., the battery cycling life is significantly improved, and maximum amount of stored energy and current becomes available for powering electrical equipment.

The technology has been extensively tested on Li-ion, Li-polymer, Lead-Acid, NiMH, and many other battery chemistries, and super-capacitors without causing any damage. The technology is implemented without making any modifications to the battery and can bring batteries to their optimal operating and charging temperatures at environmental temperatures that could be as low as −60° C. without any damage.

The disclosed high-frequency AC current direct electrolyte heating technology is inherently highly efficient and safe and can be readily integrated into any battery safety and protection circuitry and readily integrated into battery chargers. The following are some of the main characteristics of the proposed technology:
It requires no modification to the battery.
The basic physics of the process and extensive tests clearly show that the high-frequency direct electrolyte heating would not damage or reduce battery life cycle. In fact, by using and charging batteries at their optimal temperature, their cycle life is significantly increased, and maximum amount of stored energy and current becomes available.
The high-frequency electrolyte heating circuit may either be powered by external sources or use the battery power for self-heating to maintain its core temperature at the optimal level.
The battery pack protection electronic units, such as those for Lithium-ion and Lithium-polymer batteries, can be readily modified to ensure continuous high-performance charging and operation at low temperatures.
The battery electrolyte is directly and uniformly heated, therefore bringing a very cold battery to its optimal operating temperature very rapidly and minimizing heat loss from the battery.
Direct electrolyte heating requires significantly less electrical energy than external heating with heating pads or blankets or by internally provided electrical heating members.
Standard sized Li-ion or Li-polymer batteries can be used instead of thin and flat battery stack packaging to accelerate external heating via heating blankets or the like.
The technology is simple, uses commonly used electronic components, can be packaged in small volumes, and is low-cost.

The performance of all batteries is degraded significantly at low temperatures. This is the case for both primary and rechargeable batteries. In addition, current Lithium-ion and Lithium-polymer battery technology does not allow battery charging at temperatures below 0° C. and charging at temperatures below their optimal level has been shown to reduce battery life cycle. In very cold environments in which the temperature could fall to −10° C., −20° C., and at times as low as −40° C. even lower, batteries can only provide a very small percentage of their stored energy and current, sometimes less than 5-10 percent and in some cases effectively none. For rechargeable batteries, particularly for high energy density batteries of interest in most applications, such as Li-ion and Li-polymer batteries, battery charging as well as operation at low and particularly at very low temperatures raises issues that if unsolved would prevent their use for powering many systems of interest.

Some of the main issues limiting the use of any chemical battery, particularly high-density rechargeable batteries, such as Li-ion or Li-polymer batteries, are briefly reviewed below, followed a description of currently available or under development technologies to address these issues and their shortcomings, followed by the description of how the disclosed high-frequency AC current direct battery electrolyte heating technology would address all the indicated issues for operating various battery-operated devices in cold and even extreme cold environments.

### a) Decreased Discharge Capacity of Li-Ion Batteries at Low Temperature

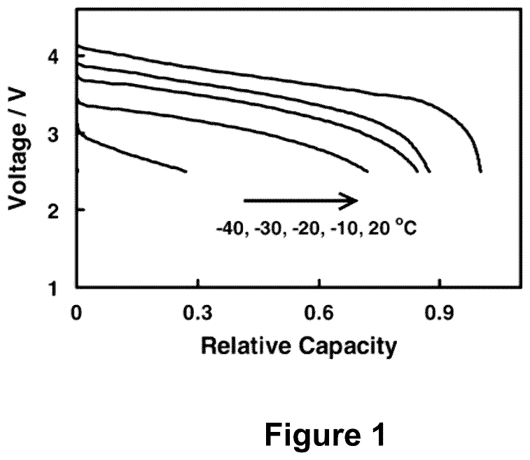

The discharge performance of Lithium-ion batteries is significantly decreased as the temperature falls below −10° C., as shown in FIG. 1. For example, at −40° C., commercial 18650 Li-ion batteries can only deliver 5% of the energy density, and 1.25% of the power density than at 20° C. (G. Nagasubramanian, “Electrical characteristics of 18650 Li-ion cells at low temperatures,” Journal of Applied Electrochemistry, vol. 31, pp. 99-104, 2001). This also applies to Li-polymer and other similarly designed batteries. The decrease in the ionic conductivity of the electrolyte and the solid electrolyte interface (SEI) layer; and the limited diffusivity of Lithium ions within the graphite anode electrodes are not the only contributors to the poor low temperature performance. In fact, when the temperature falls below −10° C., the dominant component is the slow kinetics of the battery reactions (S. S. Zhang, K. Xu and T. R. Jow, “The low temperature performance of Li-ion batteries,” Journal of Power Sources, vol. 115, pp. 137-140, 2003). Therefore, solutions that call for the use of more ionically conductive electrolytes, or additives to improve the anode electrode conductivity to improve low temperature performance are not good enough solutions at very low temperatures. The thermodynamics of the Lithium ions intercalation/de-intercalation process and the kinetics of the redox reactions ultimately determine the maximum possible discharge capacity of a lithium-ion battery at low temperatures.

### b) Low Temperature Charging

Charging a standard Li-ion and Li-polymer and other similar batteries below 0° C. must always be avoided. During the charging process, the low temperature causes the negative electrode's lattice to contract, leaving insufficient space for lithium ions to intercalate. In addition, the charge transfer and solid-phase diffusion processes slow down significantly at low temperatures. This results in the formation of lithium metal deposits (e.g., Lithium plating) on the surface of the negative electrode. The formation of lithium metal deposits causes irreversible loss of battery capacity since this fixed lithium is not available any longer during the discharge step. The larger the charging current, the more severe the damage to the electrode structure, and the faster the battery loses irreversible capacity. Further, the non-homogeneous growth of lithium metal deposits can easily form lithium dendrites that can grow large enough to puncture through the polymeric separator and short the battery, causing internal hot spots and potential for a fire or explosion of the battery.

c) Accelerated Aging when Li-ion Batteries are Cycled in Low Temperature Conditions

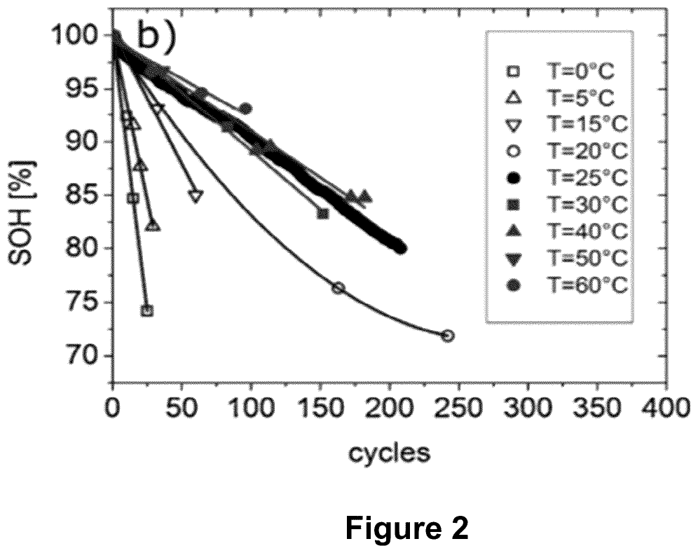

It has been widely reported (for example, Waldman, T, M. Kasper, M. Wilka, M. Fleischammer and M. Wohlfahrt, “Temperature dependent aging mechanisms in Lithium-ion batteries-A Post-Mortem study,” Journal of Power Sources, vol. 262, pp. 129-135, 2014), that commercial 18650-type Li-ion batteries age significantly faster when they are operated in low temperature conditions. FIG. 2 illustrates the effect of temperature on the number of charge/discharge cycles before the state of health (SOH) of the battery drops below 80%. The aging rate increases exponentially (Arrhenius dependency) with a drop in temperature. For example, if a battery is continuously operated at 5° C., the number of cycles before it reaches an 80% SOH is only 10% than if the battery is operated at 25° C.

### d) Electrolyte Freezing at Ultra Low Temperature

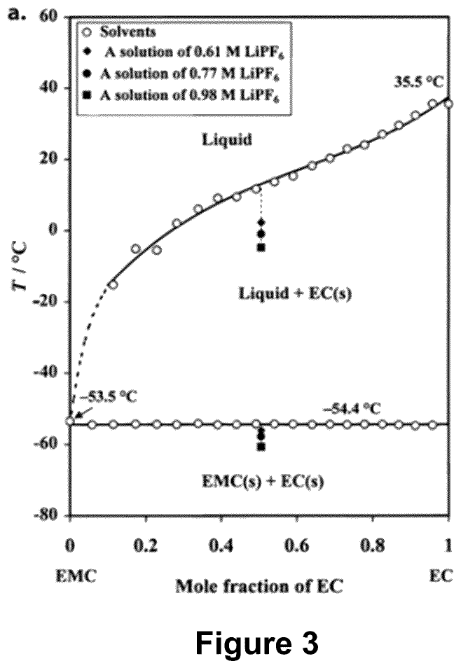

The standard Li-ion battery electrolyte comprises mixtures of two liquid organic carbonates (e.g., 50% mol fraction of ethylene carbonate EC, 50% mol fraction of ethyl methyl carbonate, EMC), and a Lithium salt (e.g., Lithium hexafluoro phosphate, LiPF6). On their own, EC and EMC freeze at 35.5° C., and at −53.5° C., respectively. FIG. 3 shows the liquidus point of mixtures of EC+EMC (M. S. Ding, X. Kang and R. Jow, “Liquid-Solid Phase Diagrams of Binary Carbonates for Lithium Batteries,” Journal of the Electrochemical Society, vol. 147, no. 5, pp. 1688-1694, 2000). The liquidus point of a 50% vol. EC/EMC mixture is around 10° C. The addition of 1M LiPF6 Lithium salt depresses the liquidus point down to −10° C. In fact, this is the recommended low temperature usable range of lithium-ion batteries, because if the temperature is dropped below the liquidus point, the first solids of electrolyte start to appear. As the temperature is further decreased, more and more solids form until the entire electrolyte volume freezes solid below −60° C. If the temperature is increased, battery capacity is recovered as the electrolyte remelts. However, small amounts of the Lithium salt LiPF6 might remain undissolved in the liquid electrolyte. Thus, with every freezing-thawing cycle, the battery loses some capacity as more and more LiFP6 salt remains undissolved. Therefore, if a battery is regularly exposed to very low temperatures, even without being used, it will eventually lose all capacity.

The currently available or under development technologies to address the above issues and their shortcomings are described below.

### Review of Currently Available Battery Heating Technology

The only currently available technology for heating batteries in cold temperature environments so that they can be charged without battery damage and be conditioned to effectively provide their stored energy and current to power various battery-operated devices in cold environments are: (1) “self-internal heating”, in which the hattery is heated through internal resistance of the battery. The so-called “mutual pulse heating” is also in this category since it also heats the battery through its internal resistance, even though the heating current is supplied by the paired batteries; (2) heating batteries by externally generated heat, such as by heating pads or heating blankets, or convective heating by blowing heated air through the battery pack or the like; (3) heating batteries via internally provided electrical heating members, which are powered by either external sources or by the battery power.

### Shortcomings of Currently Available Battery Heating Methods for Cold Environments

The above basic categories of battery heating methods have shortcomings that make them impractical and/or undesirable for a wide range of systems and devices for operation in cold environments, in particular operation in extreme cold environments. These shortcomings may be described briefly as follows:

### 1) Self-Internal Heating:

In these methods, the battery is heated through internal resistance of the battery. In operation in cold and particularly in extreme cold environments, even when the load is using the maximum available current, the amount of generated heat is not enough to keep the battery warm, and its temperature would rapidly drop as the battery temperature drops followed by available current drop in a vicious cycle that would quickly lead to the lack of enough current to power the intended device. The only general option for heating through internal resistance would then be the use of the so-called “mutual pulse heating”, which for the very cold and extreme cold environment operation would require the application of very high (effectively DC) currents (using DC-DC converters) through the battery, which would damage the battery.

### 2) Heating by Externally Generated Heat:

In this method, heat is generated by externally positioned heating elements such as resistive heating coils, and used to heat the battery through conduction, for example by heating pads or blankets, or through convection, by blowing a hot medium such as air over the batteries. The power to generate heat may be from external sources or from the battery itself. Heat conduction inside the battery pack becomes the limiting factor due to the thickness of the battery cell and the insulating nature of the outer battery layers. This leads to a large temperature gradient inside the battery. As a result, these heating methods are not energy efficient and have slow heating rates. In addition, the heating pads and blankets and other heating components significantly increase the total occupied power source volume, and thereby also the amount of energy needed to keep the battery warm and compensate for the increased heat loss through the increased outside surfaces of the power source. In short, these methods are impractical and undesirable for a wide range of systems and device powering for cold environments and particularly for extreme cold environments.

### 3) Heating by Internally Provided Electrical Heating Members:

This method heats up the battery, by Joule heating, through the addition of internally provided electrical resistance heating elements within the battery. The heating power may be supplied by external sources or some of the internal battery power may be diverted through the resistance elements. However, for rapid heating rates that are required for operation in very cold environments, high current heating rates are required, which would create high overpotential. Therefore, heating during the charging step should be avoided to prevent plating of Lᵢ metal. Large temperature gradients and hot spots are possible, which can cause high temperature electrolyte degradation, off-gassing, and ultimately fire and explosion hazards.

### High-Frequency Battery Heating for Cold and Extreme Cold Environments

The disclosed developed model of a typical battery that represents the dynamic behavior of its electrolyte when subjected to high-frequency AC current was presented in Figure The process of battery electrolyte heating with the applied high-frequency AC current and its basic physics were also described. The battery heating rate, equation (9), was then derived through the formulation of the heating process using the battery model of FIG. 5, equations (1)-(6).

Here, another example of the application of high-frequency battery electrolyte heating is presented for a Li-ion battery. Actual tests performed to validate the developed model and the method used to determine the parameters of the model for a selected small Lithium-ion battery are then presented. Actual test results of the selected Lithium-ion battery heating at temperatures as low as −58° C. is also presented. The results of self-heating tests for keeping battery core temperature at room temperature in a −60° C. environment is also provided.

In this example, the high-frequency circuit model for battery heating of FIG. 5 and the derived heating rate equation (9) were validated again as described below using a Li-ion battery model RCR123A. This is a 3.7 V (800 mAh) cylindrical cell, which is 17 mm in diameter and 34.5 mm in length.

### Determining the Model Parameters

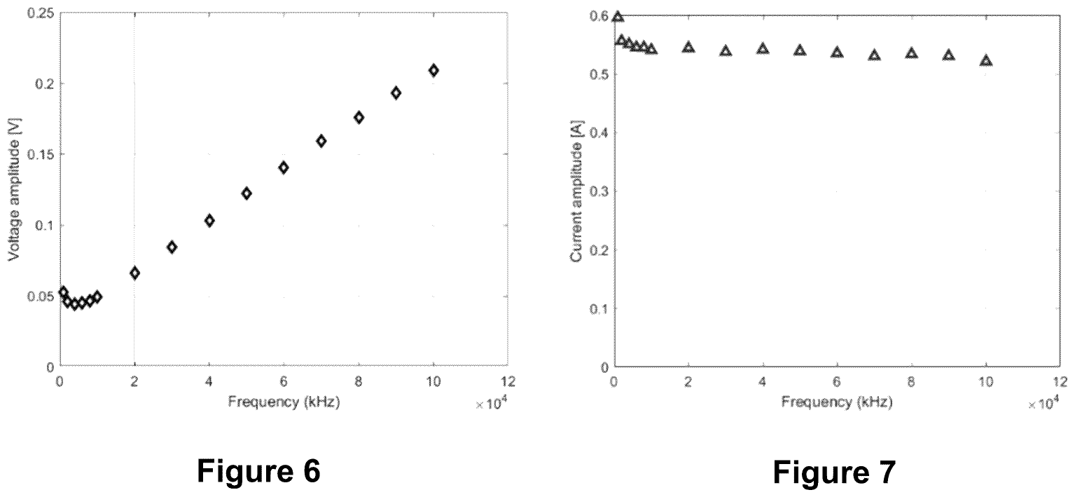

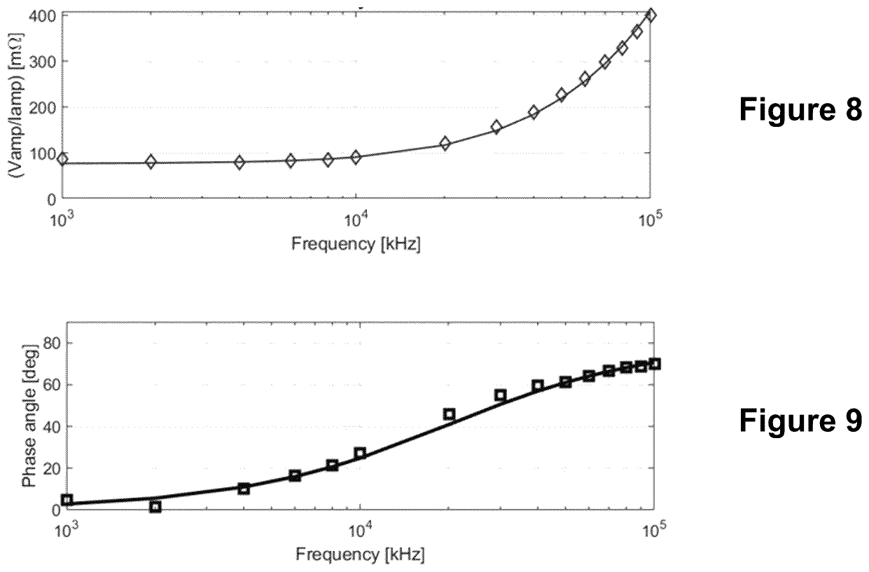

The frequency response of the above test battery at room temperature (20° C.) was characterized over a range of frequencies from 1 kHz to 100 kHz by driving the battery with a low amplitude AC sinusoidal current signal. Both the applied AC current and the corresponding AC voltage were measured at the applied frequency. The voltage and current data from the entire frequency scan was processed as was previously described to extract the ratio of the voltage to current amplitudes and the phase shift between the voltage and current waveforms. FIGS. 6 and 7 show the measured voltage and current amplitudes across the above frequency sweep, respectively.

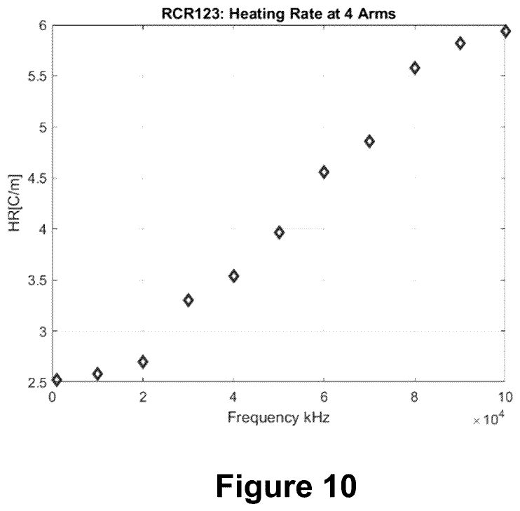

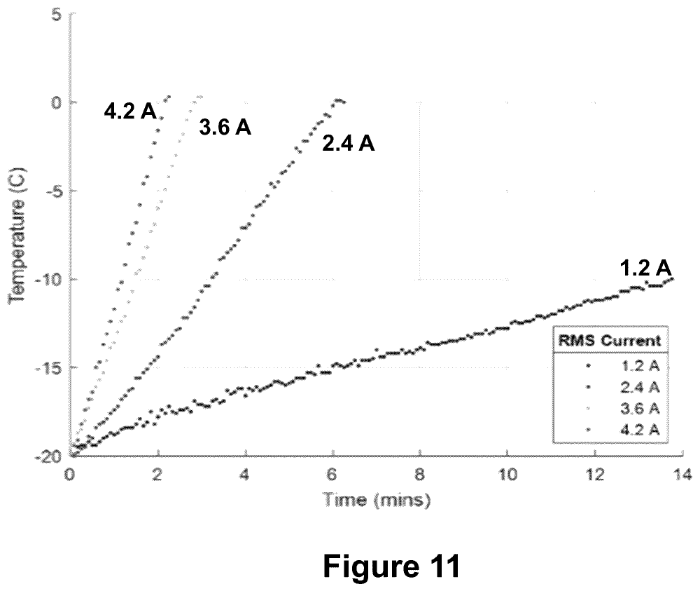

The voltage and current data of the plots of FIGS. 6 and 7 are then combined to extract the amplitude ratio of the voltage and current, which is plotted in FIG. 8. The phase angle (leading) between the voltage and current waveforms of FIG. 9 was extracted directly from voltage and current waveforms.

As can be seen in the plots of FIGS. 8 and 9, as the frequency is increased, the phase shift is increased and approaches 90 degrees, which means that the battery is exhibiting the characteristics of an equivalent non-ideal inductive element. This is exactly the behavior predicted by equations (4) and (5), which include an equivalent frequency dependent heating element R(f) and an ideal reactive inductance X(f) (=2πfL).

The data in FIGS. 8 and 9 is then combined to extract data of the corresponding R(f) and X(f). Using the corresponding models expressed in equation (2), unknown model coefficients P₀ and P₁ are extracted by fitting to R(f) data and coefficient P₂ is obtained by fitting to X(f) data. Subsequently, the unknown coefficients are found to be P₀=77.5 mΩ, P₁=5.863×10⁻⁴ me/Hz and P₂=3.9×10⁻³ mS)/Hz for the tested battery. The solid lines in FIGS. 8 and 9 show the fitted curves obtained using these parameters in equations (4) and (5). It is appreciated that the above parameters are for the battery at room temperature.

Determining the heat rate HR(I, f)

At a given temperature, the frequency and current dependent heat rate equation (9) is then obtained for the tested RCR123 Li-ion battery by using the above model coefficients, combined with the knowledge of the physical characteristics of the tested battery. In the case of the tested RCR123A Li-ion, the mass m=0.018 kg and the specific heat capacity is Cₚ=800 J/(kg° C.). Using these values, the battery dependent parameter β, equation (8), becomes

β=mCₚ=(0.018 kg)(800 jkg⁻¹.° C.⁻¹)=14.4 J.° C.⁻¹ (10)

It should be noted that the value Cₚ is an approximation, based on range of values (700 to 900 J/(kg° C.)) found in the literature. Now substituting the values of P₀, P₁ and β into equation (9), the heating rate for the tested battery (RCR123) at room temperature is given as

HR(f,I)=6.95×10⁻⁵[77.5+0.586×10⁻³f]I²[° C. is] (11)

where f is in Hz and I is the RMS current in A.

### Test Results for the RCR123A Battery

The experimental data reported below was acquired using the following facilities and equipment. All low temperatures tests were performed in the Test Equity Temperature Chamber Model #115A, AC battery current was measured using a Rogowski current probe (PEMUK CWT/15/B), and AC battery voltage was measured using a Keysight differential voltage probe (#N2791A). Battery temperature was measured using a J-Type thermocouple (#SRTC-TT-K-20-36) and the temperature profile recorded using a DigiSense logger (#20250-03). As it was not possible to mount a thermocouple inside the test battery (RCR123A), it was mounted on the outer surface of the battery, midway along its length and insulated from the ambient convection heat transfer with a 3 mm thick patch of FiberFrax 3 mm sheet (produced by Unifrax Corporation).

The heating rate equation (11) was validated by performing measurements on Li-ion test battery RCR123A, which has a voltage of 3.7 V and capacity of 800 mAh. Other presented battery heating tests were also performed with the same type of battery.

At a given battery temperature, the heating rate equation (11) is proportional to both the square of the RMS value and the frequency of the AC heating current. These two dependencies were evaluated independently as described below.

### Heating Rate as a Function of the AC Current Frequency

To verify the frequency dependence of the heating rate as described by equation (11), measurements were performed on one of the aforementioned RCR123A batteries placed in the open room environment. AC heating current over a range of frequencies from 1 kHz to 100 kHz was injected into the battery at an RMS amplitude of 4 A at all frequencies. The battery temperature was measured before and after injecting the AC heating current for 90s. The heating rate HR (° C./min) was obtained from the temperature difference at the start and end of the heating duration.

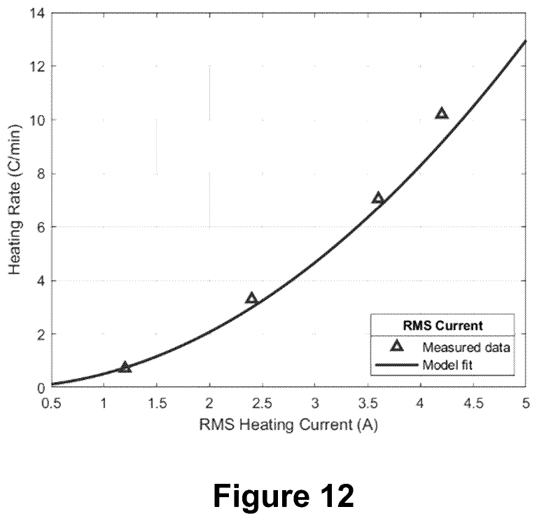

FIG. 10 shows a plot of the heating rate at room temperature of a RCR123A Li-ion battery as a function of the AC heating current frequency at a constant RMS value of 4 A.

FIG. 10 confirms that the heat generated by high-frequency AC currents in the battery electrolyte increases rapidly with increasing frequency. The heat generated due to the ion-ion and ion and electrolyte medium interactions, is a non-linear phenomenon, which reaches a peak value at some high frequency, and beyond that frequency the heat generation is seen to begin to decrease. This phenomenon has not been studied in electrolytes and is expected to be due to the “gaps” generated between the ions and their charges and the electrolyte medium at high frequencies as the ions undergo oscillatory motion. The presence of a heating rate peak frequency is also shown in Lead-acid heating rate measurements as a function of frequency presented later in this disclosure.

For the RCR123 Li-ion batteries tested, this optimal heating frequency was around 80 kHz, whereas the measurements with 12 V Lead-acid batteries show an optimal heating frequency of −40 kHz. The Lead-acid data is presented later in this disclosure.

The measured heating rate is close to 3.9° C./min, which is close to the estimated heating rate of around 5° C./min (7° C./min minus the measured heat loss rate of 2° C./min).

### Validation of the Developed Heating Rate Model:

For this test, the battery was wrapped in a FiberFrax 3 mm sheet insulation and placed in an insulated box and placed in the environment test chamber. This testing arrangement minimized heat loss from the battery during heating. The heating rate test was then performed at a frequency of 80 kHz and at four different RMS AC current levels.

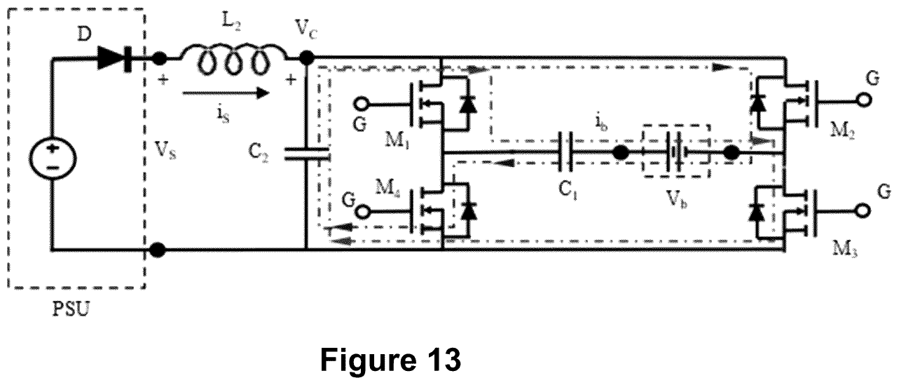

For each current level, the environment temperature was set to −20° C. and the battery was heated until the battery temperature reached 0° C. As the heating rate is nearly constant over the temperature of 0° C. to 20° C., the model parameters measured at room temperature could be used for the present model validation purposes. FIG. 11 shows the temperature profiles of the battery electrolyte temperature as a function of time for the four AC current amplitudes. The heating rates were calculated from the nearly linear heating profiles of FIG. 11.

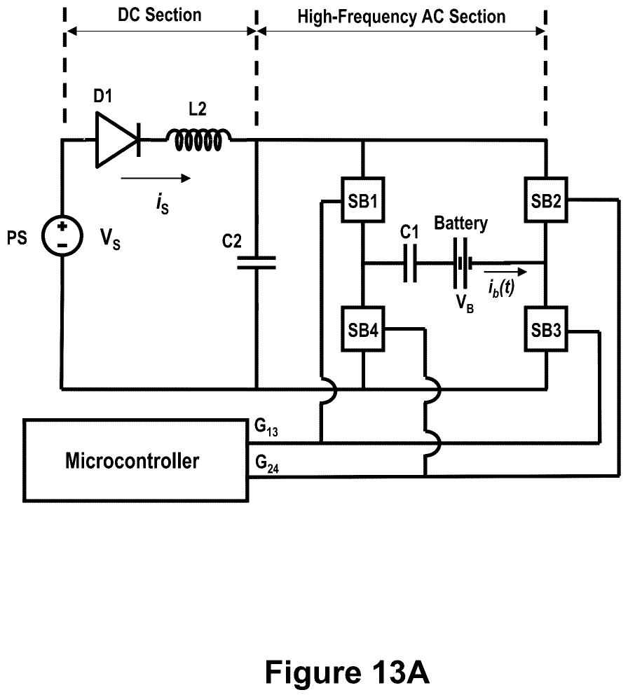

The heating rate data (symbols) as well as the heating rate calculated from the model (solid line), equation (11), are shown in the plot of FIG. 12. The measured data (symbols) is observed to show very good agreement with the predicted (solid line) heating rate described by equation (11).

### High-Frequency Direct Battery Electrolyte Heating Device Powered by an External Power Source

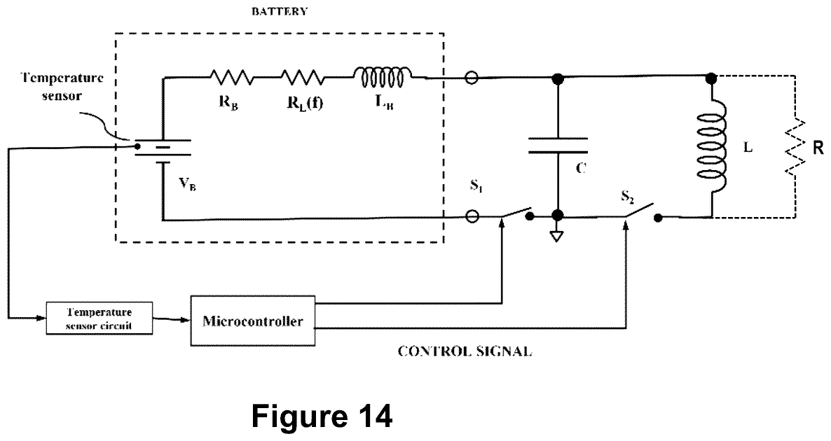

FIG. 13A shows a block diagram of a high-frequency current heating device, which is powered by an external single polarity DC power source. The circuit diagram of the device is shown in FIG. 13. This device is used for heating batteries, such as the present single cell RCR123A 3.7 V (800 mAh) Li-ion batteries as well as 36 V (850 Ah) Lead-acid batteries weighing 928 kg. It is noted that as it is described below, the high-frequency current being passed through the battery for electrolyte heating is symmetric, i.e., it has no net DC component.

The high-frequency heating current device of block diagram of FIG. 13A is powered by a DC power source PS. The flow of oscillatory high-frequency heating currents thought the battery is provided by the MOSFET switch banks SB1, SB2, SB3 and SB4, which are controlled by the microcontroller.

Once the heating system is turned on, the current flows through the diode D1 and inductor L2 and charges the capacitor C2. The diode D1 and the inductor L2 are provided to prevent backflow of DC and high-frequency current into the power source. The high-frequency current is generated by the sequential opening and closing of the MOSFET switch banks SB1, SB2, SB3 and SB4 by the microcontroller as follows. By opening the switch banks SB2 and SB4, and closing the switch banks SB1 and SB3, the current i_{b}(t) flows from the capacitor C2 through the battery in the direction of the arrow shown in FIG. 13A. The microcontroller would then close the switch banks SB1 and SB3 and close the switch banks SB2 and SB4, thereby passing the current i_{b}(t) through the battery in the opposite direction. The DC link capacitor C2 is appropriately sized to meet the peak current demand of the high frequency heating circuit. The capacitor C1 is provided to achieve AC coupling with the battery and can be provided to have low capacitance.

The MOSFETs can be switched OFF/ON at or close to the zero crossings of the high frequency AC battery current. This would minimize their switching losses. Further improvements in circuit efficiency may be attained by using a parallel array of low ESR AC coupling capacitors (not shown).

A typical circuit diagram of the high-frequency current battery heating device with the block diagram of FIG. 13A is shown in FIG. 13. In the circuit of FIG. 13, the MOSFET switches M1, M3 and M2 and M4 correspond to the MOSFET switch banks SB1, SB2, SB3 and SB4, respectively. The wirings of the MOSFET switches M1, M3 and M2 and M4 and the microcontrollers are not shown for the sake of clarity. The high-frequency current battery heating device operates as it was described in the block diagram of FIG. 13A.

### High-Frequency Heating Circuit Powered by the Battery for “Self-Heating”

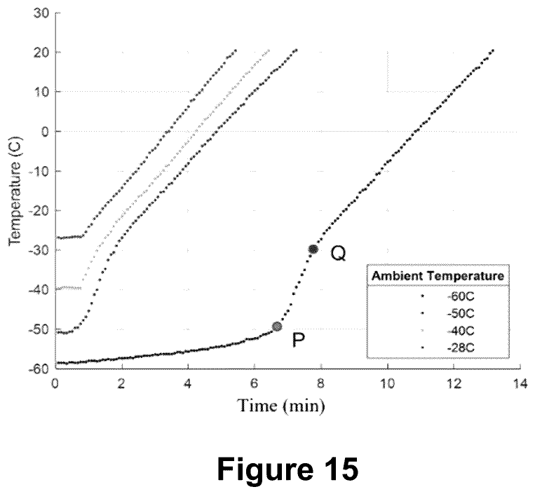

FIG. 14 shows the schematic of the novel basic high-frequency battery electrolyte self-heating circuit, which is used to describe the method of designing such novel high-frequency battery electrolyte heating devices that are powered by the battery itself. This circuit has been fabricated and used for self-heating battery electrolytes on many Li-ion and Lead-acid batteries, examples of these tests are provided below.

The high-frequency battery electrolyte self-heating circuit of FIG. 14 operates as follows. The “temperature sensor circuit” is used to monitor the battery temperature and provides the information to the system microcontroller, FIG. 14. Such temperature sensors are well known in the art. Then when the battery temperature reaches a prescribed threshold, which is usually set at different levels depending on the type, size, and operating conditions of the battery, then the microcontroller is programmed to start the process of heating the battery electrolyte.

Normally, the switches S1 and S2, which are usually made with well-known MOSFET switch banks, are open. The electrolyte heating process is then started by the system microcontroller by closing the switch S1 and leaving the switch S2 open. During this phase, a series RLC circuit is formed by the internal equivalent electric circuit components of the previously described high-frequency model of the battery (in enclosed dashed lines) and the external capacitance C. The RLC circuit oscillates until the capacitor C reaches the battery voltage and the current flow ceases. The resulting oscillating high-frequency current passing through the battery, i.e., through the frequency dependent battery resistances RB and R_{L}(f), produces heat in the battery electrolyte. Selection of the external capacitance is a trade-off between the peak current amplitude and the required resonant heating frequency. The former is proportional to the square root of the capacitance while the latter is inversely proportional to the square root of C. In some cases, an external inductor is required to be provided in series with the battery to satisfy the dual requirements of the peak current and the heating frequency.

To restart the heating cycle, the charged capacitor C must be discharged rapidly. Normally, this discharge can be performed by converting the energy by an external load resistor, such as the resistor R, FIG. 14, which is shown with dashed lines and can be provided in place of the inductor L and converting it to heat. However, wasted battery energy in the resistor R can be mostly recovered and used for battery heating using the following method.

In this method, to recover the wasted battery energy that is converted to heat by the resistor R, the energy is momentarily stored in another medium, in this case the inductor L, FIG. 14, and then used to excite the aforementioned RLC circuit and pass the indicated oscillatory high-frequency current through the battery. This is achieved as follows. Once the capacitor C reaches the battery voltage and the current flow ceases following closing the switch S₁ (switch S2 being open), the system microcontroller, FIG. 14, closes the electronic switch S2 and opens the electronic switch S₁. The electrical energy stored in the capacitor C is thereby allowed to oscillate between the capacitor C and the inductor L for one half cycle, when the inductor has returned the stored energy back to the capacitor C, but with opposite polarity, the electronic switch S2 is closed and the electronic switch S₁ is opened by the microcontroller. The aforementioned RLC circuit would then oscillate until the capacitor C reaches the battery voltage and the current flow ceases. The resulting oscillating high-frequency current passing through the battery, i.e., through the frequency dependent battery resistances RB and R_{L}(f), produces heat in the battery electrolyte.

### Examples of High-Frequency Li-Ion CR123 Battery in Various Cold Temperature Environments

In the following examples, the results of tests on the aforementioned Li-ion CR123 batteries using the high-frequency AC current battery heating circuits, FIGS. 13A, 13B, and 14 are presented. The tests are performed to confirm the efficacy of the present high-frequency AC current direct heating of battery electrolytes in cold as well as extreme cold environments. The batteries are placed in an environment chamber that was set to the desired low temperature and was left in the chamber for several hours to ensure that the entire battery body is at the set chamber temperature. The batteries were then heated with each one of the above circuits until their surface temperature was measured to be at room temperature level of 20° C.

### High-Frequency Heating of a Li-Ion CR123 Battery Using an External Power Source

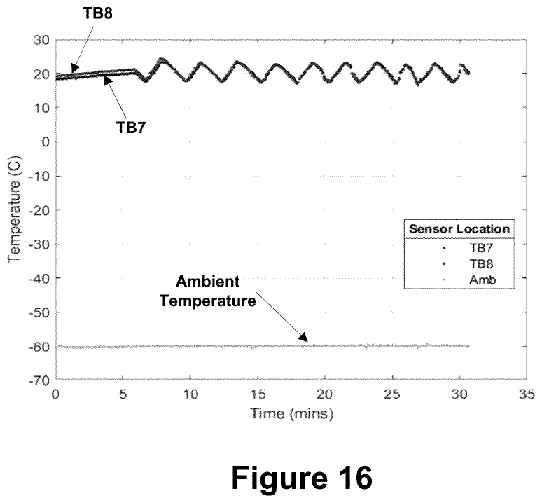

In these tests, a Li-ion CR123 battery was heated by high-frequency AC current, which is powered by an external source emulating the high-frequency heating circuit presented in FIGS. 13A and 13B, from the selected low temperatures until its surface temperature reached the room temperature level of 20° C. The tests were performed at starting environment chamber temperatures of −30° C., −40° C., −50° C., and −60° C. In each case, the battery was heated continuously using a high-frequency system comprising of a function generator, a linear amplifier, a step-down transformer, and a DC blocking capacitor until the battery electrolyte temperature reached 20° C. The temperature profile plots are shown in FIG. 15 and show very similar temperature response for all initial cold temperatures. At the extreme temperature environment of −60° C., the initial rise in battery temperature is slow until it reaches the point P, most likely due to the “frozen” electrolyte. Subsequently, following a “phase change” around −50° C. (P), the battery temperature begins to rise rapidly like the other three profiles. It is appreciated that in the latter case of the −60° C. initial battery temperature, the heating rate was limited by the ability of the heating circuit to source the required load current demand, which can be solved by allowing simple modification of the circuit to provide higher voltage levels until the battery temperature has reached around −50° C., i.e., point P. Beyond the point Q, the high frequency heating circuit would again operate in the current limit mode, sourcing ˜4 A.

### Maintaining a Li-Ion CR123 Battery at Room Temperature in a −60° C. Extreme Cold Environment

In this test, the test Li-ion CR123 battery was wrapped loosely with the aforementioned FiberFrax 3 mm sheet to eliminate convective heat transfer and placed in the temperature environment. The environmental temperature was dropped to −60° C. and the battery was heated periodically to maintain its core temperature between 18° C. and 20° C. using the same high-frequency battery heating method described for the heating rate tests of FIG. 15. To keep the battery temperature within the indicated 18° C. and 20° C. range, an average of around 92 J/minute was measured to have been supplied by the external power source.

### Maintaining the Battery Core at Room Temperature Using High-Frequency Self-Heating in Extreme Cold Environment of −60° C.

The self-heating feasibility test was performed on a serial connection of two CR123 Li-ion batteries, with an open circuit voltage of 8.3 V. During this test, the two batteries were connected in series for two reasons: (1) to demonstrate that battery heating is homogeneous even when the batteries are distributed, and (2) to enable the use of a self-heating test circuit developed for a 12 V battery. The two batteries were loosely insulated by wrapping them in a FiberFrax 3 mm sheet material and the self-heating test circuit. To determine the battery energy consumed in keeping the battery at a temperature of 20° C.±2° C., while the environment chamber was kept at −60° C., the two batteries were mounted in a holder and placed inside the environment chamber. Two separate thermocouples (marked as TB7 and TB8) were mounted on the surface of the two batteries to measure the temperature of each battery.

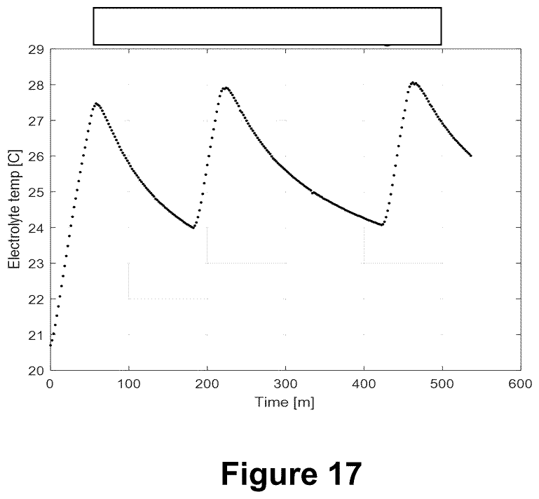

After installation in the environment chamber, the heating circuit described for the heating rate tests of FIG. 15 with externally provided power was used to keep the battery at 20° C. as the chamber temperature dropped to −60° C. Once the environment temperature reached the set point of −60° C., the externally powered heating was stopped, and the self-heating circuit of FIG. 14 was enabled (heat ON) at a battery temperature of 18° C. and disabled at a battery temperature of 22° C. FIG. 16 shows that the self-heating circuit was holding the battery temperature at 20° C. +/−2° C. FIG. 16 also shows that the output of the two battery temperature sensors (TB7 and TB8) are very close to each other, confirming that the two physically separated batteries are heated uniformly at the same rate.

This test clearly illustrates the capability of the disclosed embodiment to provide a simple self-heating circuit to keep battery core temperature at room temperature or any other appropriate temperature in a very cold environment. In the present test, the batteries were initially fully charged and after self-heating for 25 minutes, the batteries were taken out of the environment chamber and were allowed to warm up to room temperature. The remaining battery capacity was then measured under load at the standard discharge current of 800 mA to 3.0 V. Calculations then showed that the battery temperature could have been maintained at 20° C. +/−2° C. for around two hours via self-heating.

The above disclosed developed model of high-frequency current heating of battery electrolyte applies to all primary and rechargeable batteries, including thermal and liquid reserve batteries, and super-capacitors. The developed model was also validated experimentally. The model parameters are also shown to be readily determined from the experimental results for a given battery type and size. The results clearly shows that the developed high-frequency AC current direct electrolyte heating technology is fully capable of providing the means of keeping a battery temperature warm and within its optimal range to provide its maximum operating current and stored energy without any drop even at extremely low environmental temperatures that may reach −60° C. The power for the high-frequency heating circuit may be provided from external sources or from the battery itself.

The following are the main characteristics and advantages of using the developed high-frequency AC current technology for direct heating of battery electrolytes, particularly for integration into various systems, and for use in almost any environment in which the temperature drops below the battery optimal operation and charging for rechargeable batteries, for example, below around 17° C. for Li-ion and Li-polymer and the like batteries, and particularly operation in cold and extreme cold environments:
The high-frequency AC heating method acts directly on the electrolyte's ions, enabling fast heating of the entire liquid electrolyte volume inside the battery. The liquid electrolyte can then efficiently transfer heat to the rest of the internal battery components, such as electrodes, polymeric separator, and current collectors by thermal conduction. In this way, the heating occurs internally to the battery and very uniformly since the liquid electrolyte is everywhere, wetting all the internal elements of the battery. The result is a very uniform heating profile inside the battery with no hot spots or large thermal gradients, that could otherwise damage the liquid electrolyte or even start the thermal runway of the cathode electrodes.
The heating method does not require the modification or replacement of any internal components of the batteries, such as special low temperature electrolytes, new anode electrode materials, or others since it is implemented just through the addition of the external high AC frequency circuitry. Therefore, it is universally applicable to any existing primary and rechargeable battery, including Li-ion, Li-polymer, and so-called solid-state batteries and super-capacitors, any battery format and size as they are used in any existing system and device.
In extreme cold environments, wherein the electrolyte could completely freeze solid below −60° C., the imposed high frequency back-and-forth movement of the ions helps to completely redissolve the Lithium supporting salts back in the liquid electrolyte during the melting process. This will enable the batteries to be able to sustain multiple freezing-thawing cycles without losing discharge capacity.
The high frequency AC heating method is very energy efficient since almost all applied energy is used to heat up the electrolyte directly. Therefore, the amount of energy used from the battery to accomplish self-heating is minimum and only a small fraction of the battery capacity is used up in the process.
Internal temperature uniformity during heat up enables fast and precise feedback control with accurate temperature setpoint control. Controlling both charge and discharge temperature within an optimum narrow window maximizes battery cycle life.
The basic physics of the process and extensive tests clearly show that the high-frequency direct electrolyte heating would not damage or reduce battery life cycle. In fact, by using and charging batteries at their optimal temperature, their cycle life is significantly increased, and maximum amount of stored energy and current becomes available.
The high-frequency electrolyte heating circuit may either be powered by external sources or use the battery power for self-heating to maintain its core temperature at the optimal level.
The battery pack protection and management electronic units, such as the Battery Management Systems (BMS) for Lithium-ion and Lithium-polymer batteries, are generally not affected by the application of the high-frequency current, and can be readily modified to ensure continuous high-performance charging and operation at low temperatures.
Direct electrolyte heating requires significantly less electrical energy than external heating with heating pads or blankets or by internally provided electrical heating members.
Standard sized Li-ion or Li-polymer batteries can be used instead of thin and flat battery stack packaging to accelerate external heating via heating blankets or the like.
The technology is simple, uses commonly used electronic components, can be packaged in small volumes, and is low-cost.

In addition to the previously provided battery high-frequency AC current direct battery electrolyte heating test results, mainly on small CR123 LI-ion batteries for model validation and presentation of the method to determine model parameters through experimental measurement, two other results of tests of the applications of the high-frequency AC current direct battery electrolyte heating technology on a large Li-ion battery pack and a 928 kg Lead-acid battery pack used on lift trucks for operation in freezers at −25° C. are provided below.

### High-Frequency Heating of a Lead-Acid Battery (GNB M2701812515B) Used in Lift Trucks

A high-frequency AC current direct battery electrolyte heating circuit with the design shown in FIGS. 13A and 13B using an external DC power source is used to heat and maintain the battery electrolyte temperature in the range of 24° C. to 28° C. of a lift truck battery operating in a −25° C. freezer facility. The Lead-acid battery is 36 V with an 875 Ah capacity and weighs 928 kg.

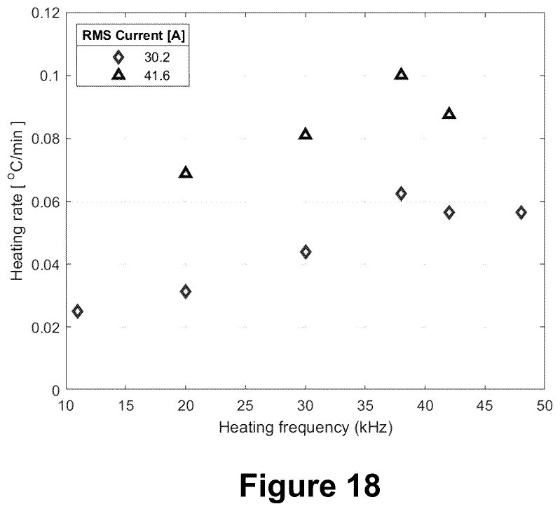

The high-frequency AC current direct battery electrolyte system was operated from a 6 V DC power source and heated at room temperature at a frequency of 30 kHz at an RMS current of 75 A. The heating was enabled when the battery temperature dropped to 24° C., and the heating was turned off when the battery reached 28° C. FIG. 17 shows the battery temperature profile over time. The measured heating rate was −0.07° C./min.

### High-Frequency Heating of a Lead-Acid AGM Battery (ArmaSafe 6TAGM) Battery

A high-frequency AC current direct battery electrolyte self-heating circuit based on the circuit of FIG. 14 was used to heat a Lead-acid AGM battery (ArmaSafe 6TAGM). The battery was instrumented and together with the self-heating circuit board was placed in the environmental chamber. The battery temperature was maintained at −18° C. in the environment chamber temperature of −40° C. (a U.S. Army requirement for truck battery with the self-heating circuit). The high-frequency AC current direct electrolyte self-heating was used to maintain the battery temperature at −18° C. for 12 hrs. The battery was initially fully charged and after the 12 hrs test, the battery was discharged to determine the percent of the total energy used during the above 12 hr test, which indicated that 25% of the available battery stored energy was used during the 12 hr test. It was then concluded that using 50% of the available stored energy in a fully charged battery, its temperature could be maintained at −18° C. in a −40° C. environment for around 24 hrs.

### Heating Rate of a 12 V Type 29HM Lead Acid Battery at Different AC Current Frequencies

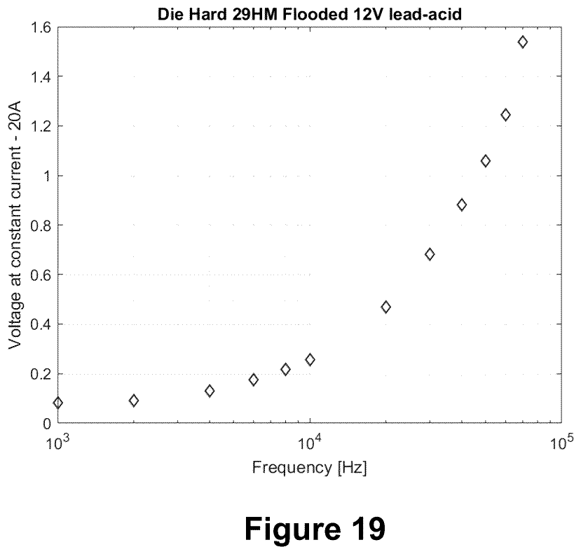

In this experiment, the objective was to verify the expected basic understanding of the physics of interaction between electrolyte ions and the electrolyte medium and between the ions, which is the mechanisms with which heat is generated when the ions are forced into high-frequency oscillatory motions. This heating mechanism suggests that the heating rate would increase with increased frequency—as was shown in the previously experimental results, but there should be a peak frequency for each battery type and size above which the heating rate would begin to drop. The reason for the drop is that above certain frequency, the high speed, and acceleration of the ions would form gaps between ions (similar to vacuum in fluids) and “impact” like interactions between the ions would reduce their number of such “impact” like interactions due to the generated gaps. Since this phenomenon can be seen at lower current frequencies in Lead-acid batteries due to the more liquid electrolyte, a 12 V Type 29HM lead acid battery was tested with constant RMS currents up to a frequency of 50 KHz. The result is shown in the plot of FIG. 18. As can be seen, a peak heating rate is reached around 37 KHz, after which the heating rate begins to drop. The same phenomenon is expected to be present in all battery electrolytes, including Li-ion batteries. Such tests are important for all batteries to determine the peak heating rate heating current frequencies when the heating rate is desired to be maximized.

It is appreciated that currently, one of the main challenges of using rechargeable batteries, such as Lithium-ion, Lithium-polymer, and other similar rechargeable batteries is the amount of relatively long time that it takes to fully charge them. This is particularly the case in Electric Vehicle (EV) and other electrically powered mobile platforms, such as trucks, lift-trucks, cranes, and the like platforms. It is, therefore, highly desirable to have methods and devices that could be used to charge batteries, such as Lithium-ion, Lithium-polymer, and other similar rechargeable batteries, at significantly higher rates that are currently available and are generally below 1C rate, so that the batteries could be charged significantly faster that is currently possible without damaging the battery and significantly reducing their cycle life.

To this end, it is highly desirable that such fast-charging methods and systems be capable of charging rechargeable batteries, such as Li-ion, Li-polymer, the so-called solid-state batteries, at rates that of over 2C-3C and even higher, without damage to the battery and reducing its cycle life. Such an innovative methods and systems are disclosed below.

In almost all rechargeable battery applications, there is a high demand for faster and faster charging rates, such as for Li-ion and other similar batteries and particularly for electric vehicles, trucks, buses, lift-trucks, and the like applications. The main problem with fast-charging, particularly at rates above 1C-3C, is lithium plating.

Research in various laboratories (e.g., Marco-Tulio F. Rodrigues et al., “Fast Charging of Lᵢ-Ion Cells: Part IV. Temperature Effects and “Safe Lines” to Avoid Lithium Plating,” 2020 J. Electrochem. Soc. 167 130508) have shown that by heating Li-ion batteries to a temperature that prevents lithium plating while limiting the growth of solid electrolyte interphase (SEI) that occurs at elevated temperatures would allow fast charging at rates that exceed 2C-3C and even up to 6C. One chosen battery charging temperature is 60° C. (140° F.), in which the battery is heated by heating elements for the duration of the charge and then cooled to about 24° C. (75° F.) with the onboard cooling system to limit the time the battery dwells at high heat. This process has been shown to enable charging of Li-ion battery at a C-rate of 6C to 80% SoC in 10 minutes.

It is appreciated that the effect of increasing the temperature of the battery electrolyte is to increase its ionic oscillatory kinetic energy. This increase in the ionic kinetic energy is responsible for the reduction in the probability of the ions to settle and collect on the surface of the battery anode under the applied DC current, i.e., to cause metal plating (in the case of Li-ion batteries, Lithium plating), which causes damage to the battery. The same oscillatory kinetic energy may be provided to the electrolyte ions, for example, the Lithium ions in the case of Li-ion batteries, by the application of the present high-frequency electric-field (i.e., the disclosed high-frequency current for battery electrolyte heating). As a result, batteries could be charged at very fast rates as was described for the case of heated batteries (for example to temperatures of around 60° C. (140° F.) for the case of Li-ion batteries), without causing battery damage (Lithium plating for the case of Li-ion batteries). In addition, damage due to the required heating of the battery to high temperatures (around 60° C. (140° F.) for the case of Li-ion batteries) and related safety issues are addressed.

It is appreciated that as it was previously described, the application of high-frequency currents to a battery causes heating of its electrolyte as expressed by equation (9). For the purpose of fast charging at high rates, the frequency of the applied current is generally selected such that the battery electrolyte temperature is not heated very rapidly, for example by selecting either lower frequencies with heating rates that would not raise the electrolyte temperature above a certain threshold while fast-charging, or by selecting significantly higher frequencies beyond the maximum heating rates, at which the heating rate would drop to an acceptable rate (as was previously described) as the battery being fast-charged. In general, fast-charging at high rates, e.g., at 3C-6C, brings the battery to 80% SoC in the order of around 10 minutes, a period of time that is not long enough to significantly increase the battery core temperature.

Thus, by integrating the disclosed high-frequency electric-field application capability (i.e., the disclosed high-frequency current for battery electrolyte heating) into the battery charger device, and superimposing a high-frequency current over the charging DC current, allows for fast-charging at high rates without battery damage due to plating (Lithium plating in the case of Li-ion batteries) similar fast-charging at high battery temperatures (e.g., around 60° C. (140° F.) for the case of Li-ion batteries), but without the damaging effects of high battery temperatures. Such integrated system embodiments of chargers with superimposing high-frequency current capability for fast-charging batteries at high rates are disclosed below.

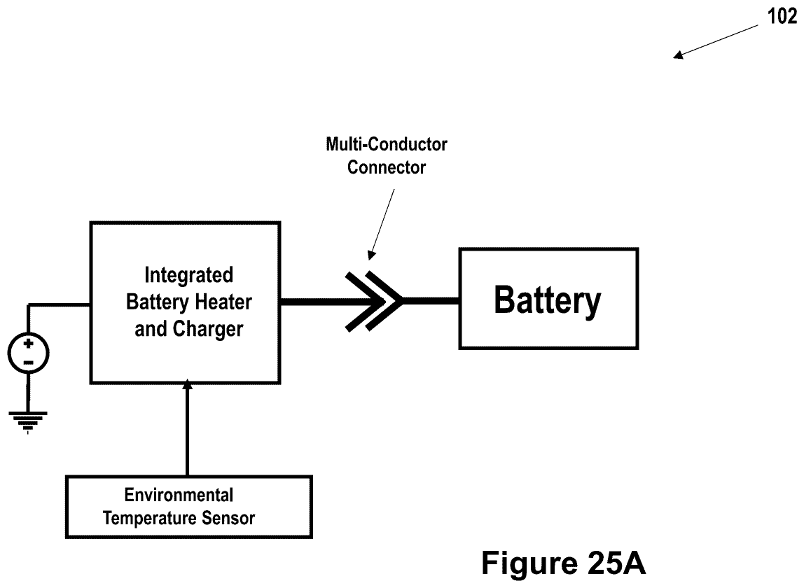

A block diagram of a rapid battery charging and high-frequency current battery electrolyte heating device system (hereinafter also referred to as the “Fast-Charger System”) embodiment 100 is shown in FIG. 25. The “Fast-Charger System” embodiment 100 of Figure is seen to be powered by an external power source. The “Fast-Charger System”) embodiment 100 of FIG. 25 is configured to charge batteries at a prescribed rate, including at very high-rates in any environmental temperatures that the battery may be used, including in cold temperatures.

The “Fast-Charger System” embodiment 100 of FIG. 25 comprises a “Battery Charger” component and a “Battery Heater/Ionic-Exciter” component, which are drawn as separate units in this illustration for the ease of system operation description but can be constructed as a single unit. The battery charger component is configured and constructed like any of the currently available high current chargers with the well-known safety and current, voltage, temperature, etc., controls. The “Battery Heater/Ionic-Exciter” component is of the previously disclosed high-frequency current battery electrolyte heating type, such the one shown in FIGS. 13A and 13.

It is appreciated that as it was previously described, for a given battery, the heating rate is increased with increased frequency of the applied current until it reaches a peak, and as the current frequency is increased further, the heating rate of the battery begins to drop. In the present “Fast-Charger System” embodiment 100 of FIG. 25, the “Battery Heater/Ionic-Exciter” component of the system is intended to operate in the following two different modes, a primarily heating mode, in which the current frequency is set at or close to its maximum heating rate, and a primarily ionic-excitation mode, in which the current frequency is generally set significantly above its maximum heating rate, when the primary purpose of the applied high-frequency current is to generate “ionic-excitation” of the electrolyte ions, thereby as was previously indicated, prevent damage to the battery by plating (e.g., Lᵢ plating in Li-ion batteries) with the application of high charging currents, such as 2C-3C or even higher.

It is appreciated by those skilled in the art that operation of the “Battery Heater/Ionic-Exciter” component in both of the above modes results in the battery electrolyte heating and generate ionic-excitation, which is the main source of battery electrolyte heating as was previously described. However, in the aforementioned battery heating mode (hereinafter referred to as “Battery Heating Mode”), the heating rate of the battery electrolyte is attempted to be maximized, while in the aforementioned “ionic excitation” mode (hereinafter referred to as “Battery Ionic-Excitation Mode”), the battery electrolyte heating rate is attempted to be minimized.

The operation of the fast-charger system 100 is controlled by a processor, such as a programmable microcontroller. The temperature of the battery being charged is measured by a provided temperature sensor, such as a well-known thermocouple or thermistor or the like, the output of which is provided to the microcontroller via an appropriate “temperature sensor circuit” shown in FIG. 25. A temperature sensor is also provided for measuring environmental temperature of the battery and provide the information to the system controller for setting an optimal process for the required battery charging and heating as described below. The system “Control Panel” provides the means for the user to turn the system on and off and set the operational requirements of the system, such as the operating temperature and its range, heating and charging rates, etc., examples of which are provided later in this disclosure.

The “Fast-Charger System” embodiment 100 of FIG. 25 operates as follows. When the system is turned on for the first time, the user will use the provided system means described below, to set the system parameters and select the provided operational options. The parameters to be provided include the battery type, size, and all other pertinent characteristic information; heating temperature threshold and its acceptable range; acceptable heating and charging rate ranges; desired charging rate according to the time of day and weekdays; the option of charging without heating (which may, for example, be selected in warm months of the year) or heating without charging (which, may be selected when heating is required to keep a charged battery warm when needed). It is appreciated that many or even all these parameters and options may be set by the equipment manufacturer or seller, particularly if it is purchased together with the equipment in which the battery is installed. In some applications, the system may be provided with a limited number of set of parameters preset options, for example for overnight charging and keeping or bringing the battery at its optimal temperature and fully charged by certain time in the morning for optimal operational performance and to maximize the battery life.

It is also appreciated by those skilled in the art that both of the above methods and means to input the required and desired charging and heating parameters and operational options (i.e., initializing the system) are well known in the art. Other well-known methods, such as factory setting of all the parameters and options for the user and providing minimal user input, usually buttons and/or switches, for the user interaction with the “Fast-Charger System”, such as on/off switch, emergency shut-down button, “Battery Heater/Ionic-Exciter” on/off switch, etc., may also be provided on the system control panel, FIG. 25.

It is appreciated that in the block diagram of FIG. 25, the switches S1 and S2 are intended to indicate the means with which the “Fast-Charger System” controller would connect/disconnect the “Battery Charger” and “Battery Heater/Ionic-Exciter” components, respectively, to/from the battery. It is appreciated by those skilled in the art that depending on the application and the size of the battery, the system designer may provide this capability by, e.g., terminating power supply to the “Battery Charger” and “Battery Heater/Ionic-Exciter” components, or provide the said switching actions within these component circuits.

Once the “Fast-Charger System” is initiated by setting all the required parameters and options as is described above, the user can turn the system on.

Once the “Fast-Charger System” is turned on, the software driven system microcontroller collects data as to the battery temperature and the battery environment temperature. The system controller is programmed to perform the following functions:
1—If the battery temperature is below a threshold that is safe for the battery to be charged, even with an applied system high-frequency current (as usually determined by the battery manufacturer), then the system controller would turn the “Battery Heater/Ionic-Exciter” on (in its “Battery Heating Mode”, when provided to the system) and keep the “Battery Charger” off. The battery temperature is then raised to the prescribed charging temperature threshold, and then the battery charger is turned on for charging at a prescribed high rate, while the “Battery Heater/Ionic-Exciter” is switched to its “Battery Ionic-Excitation Mode”.
2—The “Fast-Charger System” controller can be programmed to determine the optimal battery charging rate depending on the prescribed amount of time available for the battery to be fully (or partially) charged.
3—Once the battery is charged to the prescribed level, if the optimal temperature maintenance option has been selected by the user, the system controller would monitor the battery temperature and would turn the “Battery Heater/Ionic-Exciter” on in its “Battery Heating Mode” when the battery temperature drops below the prescribed threshold and turns it off when the battery temperature reaches its prescribed upper limit threshold.

In the above charging process, the described fast-charging protocol comprises passing a high-frequency current through the battery while performing fast-charging. Then if the battery temperature gets to a prescribed threshold level, then the high-frequency current is turned off, and the battery is charged at a low rate and if necessary, the charging is stopped until the battery has cooled down the prescribed temperature threshold. As the temperature goes up, the amplitude of high-frequency current may be reduced to reduce heating rate.

It is appreciated by those skilled in the art that the “Fast-Charger System” embodiment 100 of FIG. 25 may also operate in a slow charging mode, i.e., well below the charging rate of 1C, for example at a rate of 0.2C, when charging time is not an issue, for example when the battery is to be charged overnight. In such slow charging modes, the “Battery Heating Mode” is also used when the battery temperature is below its optimal charging temperature, to bring the charged battery temperature to its optimal operating temperature at the prescribed time for the user, and to minimize battery life reduction by charging the battery at its optimal charging temperature. In addition, the “Battery Heater/Ionic-Exciter” may also be used in its “Battery Ionic-Excitation Mode” to reduce/eliminate any potential plating damage to the battery.

It is appreciated that as it was indicated previously, the applied high-frequency current allows for battery charging at high-rates that may be over 2C-3C at lower temperatures without causing damage (plating), such as Lithium plating in Li-ion batteries.

It is appreciated by those skilled in the art that in many applications, it is highly desirable to have a fully integrated “Fast-Charger System”, in which all components of the “Fast-Charger System” embodiment 100 of FIG. 25, including its “Battery Charger”, “Battery Heater/Ionic Exciter”, “microcontroller”, and battery and environmental temperature sensory electronics, are assembled into a single unit with a single “control Panel” for input and operation by the system user interface, that is connected and disconnected to the intended battery powered system or battery-based power storage system or the like via a provided connector and wiring. Such a fully integrated “Fast-Charger System” embodiment 102 is shown in the schematic of FIG. 25A.

In the fully integrated “Fast-Charger System” embodiment 102 (hereinafter referred to as the “Integrated Fast-Charger”) is shown in the schematic of FIG. 25A, all the components of the “Fast-Charger System”, FIG. 25, as indicated by the enclosed dashed lines, together with the battery “Temperature Sensor Circuit” (unless it is provided in the battery, usually a battery pack, itself) are provided in a single housing, as marked as the “integrated Battery Heater and Charger”, with its input connection to the external power source, and input ports for the “environmental Temperature Sensor” and other communication, computer connection, software update, etc., as would be required for each specific application. The “Integrated Fast-Charger” is then connected to the “Battery” by a multi-conductor connector, which would provide connection to all provided electrical and electronic connections inside the battery pack, such as the battery temperature sensor, and controls, such as the Battery Management System (BMS) used in Li-ion battery packs. The “Control” Panel” on the “Integrated Fast-Charger” housing would also provide the same functions that was described for the embodiment 100 of FIG. 25.

It is appreciated by those skilled in the art that an advantage of integrating the components of the “Fast-Charger System” embodiment 100 of FIG. 25 into a single “Integrated Battery Heater and Charger”, FIG. 25A, is that it would significantly reduce the required number of electrical and electronic components. In general, the overall size and cost of the system are also reduced. Otherwise, the “Integrated Fast-Charger” embodiment of FIG. 25A is operated and performs its functions as was described for the “Fast-Charger System” embodiment 100 of FIG. 25.

It is appreciated by those skilled in the art that the blocks indicated as “Battery” in FIGS. 25 and 25A and all previously described and those that are described in the remainder of this disclosure are not intended to indicate only a single battery cell, but also battery packs that are customarily fabricated by parallel and in-series connection of single cell batteries to provide the required voltage and current to the intended load.

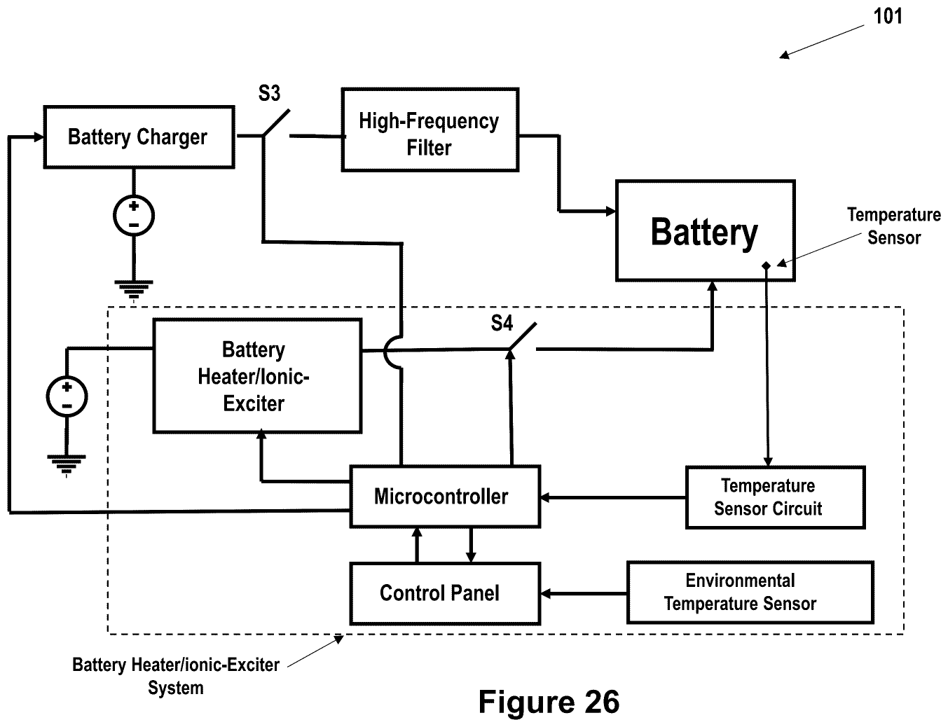

It is appreciated that a very large number of battery chargers already exists and are being used to charge various rechargeable batteries, including Li-ion, of various devices and platforms, such as electric vehicles, trucks, lift-trucks, construction, material handling equipment, and the like, which can use the disclosed fast charging technology to significantly increase the performance and market for such devices and platforms due to the challenges posed by the relatively long periods of time that it takes to charge their batteries. It is therefore highly desirable to develop methods to “convert” existing battery chargers to “fast-chargers” capable of charging batteries at high rates, such as at rates that are at or over 2C-3C. Such a method and a typical resulting “converted” “fast-charger system” embodiment 101, hereinafter referred to as the “Converted Fast-Charger System”, is described below using the block diagram of FIG. 26.

The “Converted Fast-Charger System” embodiment 101 of FIG. 26 comprises a currently available and regularly used “Battery Charger” component and a “Battery Heater/Ionic-Exciter System” component, shown in FIG. 26 with dashed lines. The “Battery Heater/Ionic-Exciter System” component comprises the “Battery Heater/Ionic-Exciter” member, which was previously disclosed and is designed to provide high-frequency heating current to the battery electrolyte, such the embodiment of FIGS. 13A and 13, and the system microcontroller which is provided inside a control unit enclosure (not shown) with a control panel shown in FIG. 26. An environmental temperature sensor, which may be positioned inside the control unit enclosure as shown in FIG. 26 or outside and close to the battery, provides information as to the temperature of the environment within which the battery is located. Both “Battery Charger” and the “Battery Heater/Ionic-Exciter System” components are externally powered.

It is appreciated by those skilled in the art that since most currently used battery chargers are not generally designed to filter high frequency currents from passing into its internal circuits, it is usually necessary to provide a “High-Frequency Filter”, FIG. 26, at the output of the battery charger to prevent high-frequency current generated by the “Battery Heater/Ionic Exciter System” from interfering with the operation of the battery charger electronics. Such “High-Frequency Filter” elements are well known in the art and are used in many battery chargers, and usually comprises a properly sized inductor element to lower the amplitude of the input high-frequency current to an acceptable level for the operation of the battery charger.

In the “Converted Fast-Charger System” embodiment 101 of FIG. 26, similar to the “Fast-Charger System” embodiment 100 of FIG. 25, the “Battery Heater/Ionic-Exciter” member operates in the two different modes, a “Battery Heating Mode”, in which the current frequency is set at or close to its maximum heating rate, and a “Battery Ionic-Excitation Mode”, in which the current frequency is generally set significantly above its maximum heating rate, when the primary purpose of the applied high-frequency current is to generate “ionic-excitation” of the electrolyte ions, thereby as was previously indicated, prevent damage to the battery by plating (e.g., Li plating in Li-ion batteries) with the application of high charging currents, such as 2C-3C or even higher.

It is appreciated by those skilled in the art that operation of the “Battery Heater/Ionic-Exciter” component in both above modes would result in the battery electrolyte heating and generate ionic-excitation, which is the main source of battery electrolyte heating as was previously described. However, in the “Battery Heating Mode”, the heating rate of the battery electrolyte is maximized, while in the “Battery Ionic-Excitation Mode”, the battery electrolyte heating rate is attempted to be minimized.

The operation of the “Converted Fast-Charger System” embodiment 101 of FIG. 26 is controlled by the provided programmable microcontroller. The temperature of the battery being charged is measured by a provided temperature sensor, such as a well-known thermocouple or thermistor or the like, the output of which is provided to the microcontroller via an appropriate “temperature sensor circuit” shown in FIG. 26. A temperature sensor is also provided for measuring environmental temperature of the battery and provide the information to the system controller for setting an optimal process for the required battery charging and heating as described previously described. The system “Control Panel” provides the means for the user to turn the system on and off and set the operational requirements of the system, such as the operating temperature and its range, heating and charging rates, etc., examples of which are provided later in this disclosure.

The “Converted Fast-Charger System” embodiment 101 of FIG. 26 operates as follows. When the system is turned on for the first time, the user will use the provided system means described below, to set the system parameters and select the provided operational options. The parameters to be provided include the battery type, size, and all other pertinent characteristic information; heating temperature threshold and its acceptable range; acceptable heating and charging rate ranges; desired charging rate according to the time of day and weekdays; the option of charging without heating or heating without charging (which, may be selected when heating is required to keep a charged battery warm when needed). It is appreciated that many or even all these parameters and options may be set by the equipment manufacturer or seller, particularly if it is purchased together with the equipment in which the battery is installed. In some applications, the system may be provided with a limited number of set of parameters preset options, for example for overnight charging and keeping or bringing the battery at its optimal temperature and fully charged by certain time in the morning for optimal operational performance and to maximize the battery life.

It is also appreciated by those skilled in the art that both of the above methods and means to input the required and desired charging and heating parameters and operational options (i.e., initializing the system) are well known in the art. Other well-known methods, such as factory setting of all the parameters and options for the user and providing minimal user input, usually buttons and/or switches, for the user interaction with the “Converted Fast-Charger System”, such as on/off switch, emergency shut-down button, “Battery Heater/Ionic-Exciter” on/off switch, etc., may also be provided on the system control panel, FIG. 26.

It is appreciated that in the block diagram of FIG. 26, the switches S3 and S4 are intended to indicate the means with which the “Converted Fast-Charger System” controller would connect/disconnect the “Battery Charger” and “Battery Heater/Ionic-Exciter” components, respectively, to/from the battery. It is appreciated by those skilled in the art that depending on the application and the size of the battery, the system designer may provide this capability by, e.g., terminating power supply to the “Battery Charger” and “Battery Heater/Ionic-Exciter” components, or provide the said switching actions within these component circuits.

Once the “Converted Fast-Charger System” embodiment 101 of FIG. 26 is initiated by setting all the required parameters and options as is described above, the user can turn the system on. Once the “Converted Fast-Charger System” is turned on, the software driven system microcontroller collects data as to the battery and battery environment temperatures and charge the battery as it was previously described for the “Fast-Charger System” embodiment 100 of FIG. 25.

The “Converted Fast-Charger System” controller can also be programmed to determine the optimal battery charging rate depending on the prescribed amount of time available for the battery to be fully (or partially) charged.

Once the battery is charged to the prescribed level, if the optimal temperature maintenance option has been selected by the user, the system controller would monitor the battery temperature and would turn the “Battery Heater/Ionic-Exciter” on in its “Battery Heating Mode” when the battery temperature drops below the prescribed threshold and turns it off when the battery temperature reaches its prescribed upper limit threshold, as for example, shown in the plot of FIG. 16.

In the above charging process, the described fast-charging protocol comprises passing a high-frequency current through the battery while performing fast-charging. Then if the battery temperature gets to a prescribed threshold level, then the high-frequency current is turned off, and the battery is charged at a low rate and if necessary, the charging is stopped until the battery has cooled down the prescribed temperature threshold. As the temperature goes up, the amplitude of high-frequency current may be reduced to reduce heating rate.

It is appreciated by those skilled in the art that the “Fast-Charger System” embodiment 101 of FIG. 26 may also operate in a slow charging mode, i.e., well below the charging rate of 1C, for example at a rate of 0.2C, when charging time is not an issue, for example when the battery is to be charged overnight. In such slow charging modes, the “Battery Heating Mode” is also used when the battery temperature is below its optimal charging temperature, to bring the charged battery temperature to its optimal operating temperature at the prescribed time for the user, and to minimize battery life reduction by charging the battery at its optimal charging temperature. In addition, the “Battery Heater/Ionic-Exciter” may also be used in its “Battery Ionic-Excitation Mode” to reduce/eliminate any potential plating damage to the battery.

It is appreciated that as it was indicated previously, the applied high-frequency current allows for battery charging at high-rates that may be over 2C-3C at lower temperatures without causing damage (plating), such as Lithium plating in Li-ion batteries.

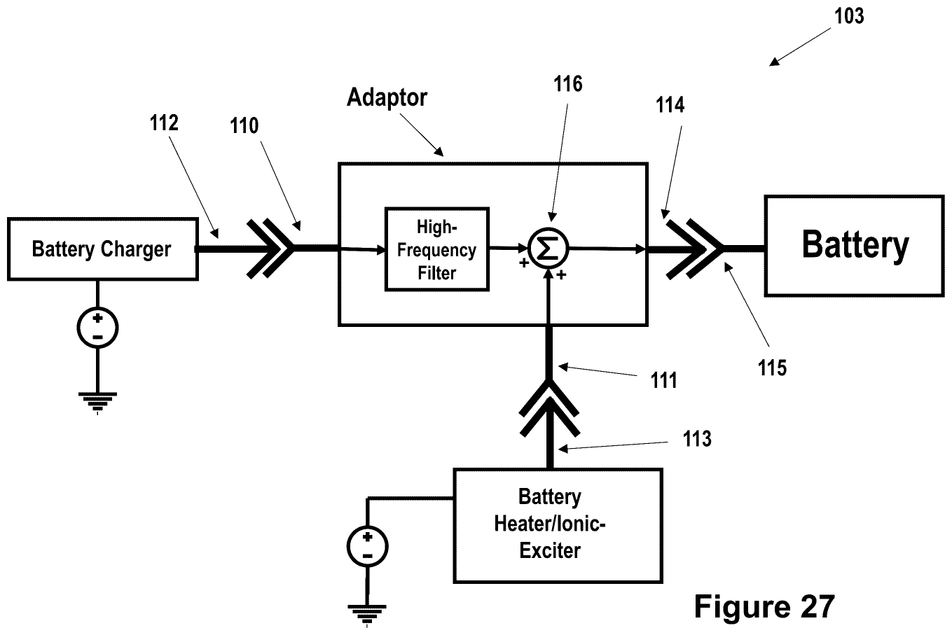

It is appreciated that there is also a need for users who already have an existing battery charger to be able to use a “Battery Heater/Ionic Exciter” unit to form a “Fast-Charger System” similar to the “Fast-Charger System” embodiment 100 of FIG. 25, for charging batteries at high rates as well as for direct heating of the battery electrolyte at low temperatures for optimal charging and operation as was previously described for the “Fast-Charger System” embodiments 100 and 101 of FIGS. 25 and 26, respectively. To achieve this goal, a properly designed “Adaptor” is needed that would allow for “in-parallel” connection of a battery charger to a “Battery Heater/Ionic Exciter” unit and then connect the adapter to the “Battery”, i.e., to the battery (usually battery pack) of the device or platform, such as an electric vehicle, truck, or the like. Such an “Adaptor” and its connection arrangements with the “Battery Charger” and “Battery Heater/Ionic Exciter” and the “Battery” is shown in the block diagram of FIG. 27.

The “Fast-Charger System” formed with the provider “Adaptor” that functions similar to the “Fast-Charger System” embodiment 100 of FIG. 25 is shown in FIG. 27 and is indicated as the embodiment 103 and is hereinafter referred to as the “Adapter-based Fast-Charger System”. The “Adaptor” is shown to be provided with two input multi-conductor connectors 110 and 111, to which the “Battery Charger” and “Battery Heater/Ionic Exciter” units are connected via their mating multi-conductor connectors 112 and 113, respectively. It is appreciated that as can be seen in the block diagram of FIG. 27, both “Battery Charger” and “Battery Heater/Ionic Exciter” units are powered by external power sources. The “Adaptor” is also provided with an output cable with a multi-conductor connector, the assembly of which is indicated by the numeral 114 in FIG. 27. The output multi-conductor connector of the “Adaptor” is then connected to the mating multi-conductor connector 115 of the “Battery” that is provided on the device, platform, vehicle, and the like that is to be charged.

It is appreciated by those skilled in the art that in general, the above “Adaptor” connectors and connector that connects the “Adaptor” to the “Battery” are needed to by multi-connector type to allow input from the battery temperature sensor to be provided to both the “Battery Charger” and the “Battery Heater/Ionic Exciter” unit controls and to connect all other existing “Battery” electronic and electrical sensory and control wirings, such as “Battery Management System” (BMS) wirings to the “Battery Charger” and the “Battery Heater/Ionic-Exciter” units.

It is appreciated by those skilled in the art that since most currently used battery chargers are not generally designed to filter high-frequency currents from passing into its internal circuits, the “Adaptor” is provided with a “High-Frequency Filter”, FIG. 27, at its “Battery Charger” input 110, the output of which is connected with the input 111 from the “Battery Heater/Ionic-Exciter” in the junction 116, in which the high-frequency AC current output of the “Battery Heater/Ionic-Exciter” is superimposed over the DC battery charging current of the “Battery Charger”. Such a “High-Frequency Filter” is generally required in the present configured system of FIG. 27 to prevent high-frequency current generated by the “Battery Heater/Ionic Exciter System” from interfering with the operation of the “Battery Charger” electronics. Such “High-Frequency Filter” elements are well known in the art and are used in many similar applications and usually comprises a properly sized inductor element to lower the amplitude of the input high-frequency current to an acceptable level for the operation of the related devices, in this case the electronics of the “Battery Charger”.

An environmental temperature sensor, which may be positioned inside the “Adaptor” unit housing (not shown), FIG. 27, is also usually provided and is used by the “Battery Heater/Ionic-Exciter System” for their proper operation as was previously described for the operation of the “Fast-Charger System” embodiment 100 of FIG. 25.

It is appreciated by those skilled in the art that as it was previously described for the “Fast-Charger System” embodiment 100 of FIG. 25, the operation of the “Battery Heater/Ionic-Exciter” component in both its modes, i.e., in its “Battery Heating Mode” and “Battery Ionic-Excitation Mode” would result in the battery electrolyte heating and generate ionic-excitation, which the latter is the main source of battery electrolyte heating as was previously described. However, as it was previously described for the embodiments of FIGS. 25 and 26, in the “Battery Heating Mode”, the heating rate of the battery electrolyte is maximized, while in the “Battery Ionic-Excitation Mode”, the battery electrolyte heating rate is attempted to be minimized.

This means that in the “Adapter-based Fast-Charger System” embodiment 103 of FIG. 27, similar to the embodiment 100 and 101 of FIGS. 25 and 26, respectively, the current frequency of the “Battery Heater/Ionic-Exciter” member is programmed to operate in its “Battery Heating Mode” when it is needed for battery electrolyte heating, in which case the current frequency is set at or close to its maximum heating rate. Then when the primary purpose of the applied high-frequency current is to generate “ionic-excitation” of the electrolyte ions, the “Battery Heater/Ionic-Exciter” is set to its “Battery Ionic-Excitation Mode”, in which the current frequency is generally set significantly above or below its maximum heating rate to reduce battery heating rate while increasing ionic excitation in the battery electrolyte, thereby as was previously indicated, prevent damage to the battery by plating (e.g., Lᵢ plating in Li-ion batteries) with the application of high charging currents, such as 2C-3C or even higher.

The operation of the “Adapter-based Fast-Charger System” embodiment 103 of FIG. 27 is also controlled by the provided, generally programmable, “Battery Charger” control unit, and the programmable microcontroller of the “Batter Heater/Ionic-Exciter System”, FIG. 26. The temperature of the battery being charged is measured by a provided temperature sensor, such as a well-known thermocouple or thermistor or the like, the output of which is provided to the microcontroller of the “Batter Heater/Ionic-Exciter System”. A temperature sensor is also provided (not shown), such as in the “Battery Heater/Ionic-Exciter” or the “Adaptor”, FIG. 27 as was previously indicated for measuring environmental temperature of the battery and provide the information to the “Battery Heater/Ionic-Exciter System” microcontroller for setting an optimal process for the required battery charging and heating as described previously described for the embodiment 101 of FIG. 26. The “Control Panels” (not shown) of the “Battery Charger” and “Battery Heater/Ionic-Exciter” units would provide the means for the user to turn the system on and off and set the operational requirements of the system, such as the operating temperature and its range, heating and charging rates, etc., as was previously described.

It is appreciated by those skilled in the art that in general, the “Adaptor” in a passive component of the “Adapter-based Fast-Charger System” embodiment 103 of FIG. 27. However, in certain applications, the “Adaptor” may be desired to provide control over the “Battery Charger” and/or “Battery Heater/Ionic Exciter” operations. In such cases, the “Adaptor” may be provided with a programmable microcontroller (not shown) and be used to direct the operation of the “Battery Charger” and/or “Battery Heater/Ionic Exciter” units by appropriately setting the parameters controlling the operation of their programmed microcontrollers. Power for the operation of the “Adaptor” microcontroller and the related electrical and electronics can be provided by the “Battery Heater/Ionic Exciter” unit, but the “Adaptor” may also be provided with its own (possibly rechargeable) batteries since it would only require a low level of electrical power to operate its components.

The “Adapter-based Fast-Charger System” embodiment 103 of FIG. 27 operates as follows. When the system is turned on for the first time, the user will use the provided system means described below, to set the system parameters and select the provided operational options for both the “Battery Charger” and for the “Battery Heater/Ionic Exciter”. The parameters to be provided include the battery type, size, and all other pertinent characteristic information; heating temperature threshold and its acceptable range; acceptable heating and charging rate ranges; desired charging rate according to the time of day and weekdays; the option of charging without heating or heating without charging (which, may be selected when heating is required to keep a charged battery warm when needed). It is appreciated that many or even all these parameters and options may be set by the equipment manufacturer or seller, particularly if it is purchased together with the equipment in which the battery is installed. In some applications, the system may be provided with a limited number of set of parameters preset options, for example for overnight charging and keeping or bringing the battery at its optimal temperature and fully charged by certain time in the morning for optimal operational performance and to maximize the battery life.

It is also appreciated by those skilled in the art that both of the above methods and means to input the required and desired charging and heating parameters and operational options (i.e., initializing the system) are well known in the art. Other well-known methods, such as factory setting of all the parameters and options for the user and providing minimal user input, usually buttons and/or switches, for the user interaction with the “Battery Charger” and for the “Battery Heater/Ionic Exciter”, such as on/off switch, emergency shut-down button, “Battery Heater/Ionic-Exciter” on/off switches, etc., may also be provided on the system component control panels.

Once the “Adapter-based Fast-Charger System” embodiment 103 of FIG. 27 is initiated by setting all the required parameters and options as is described above, the user can turn the system, i.e., the “Battery Charger” and the “Battery Heater/Ionic Exciter” on. Once the “Adapter-based Fast-Charger System” is turned on, the software driven “Battery Charger” and the “Battery Heater/Ionic Exciter” microcontrollers collects data as to the battery and battery environment temperatures and charge the battery as it was previously described for the embodiment 101 of FIG. 26. The “Adapter-based Fast-Charger System” controls can also be programmed to determine the optimal battery charging rate depending on the prescribed amount of time available for the battery to be fully (or partially) charged.

Once the battery is charged to the prescribed level, if the optimal temperature maintenance option has been selected by the user, the “Battery Heater/Ionic Exciter” controller would monitor the battery temperature and would turn the “Battery Heater/Ionic-Exciter” on in its “Battery Heating Mode” when the battery temperature drops below the prescribed threshold and turns it off when the battery temperature reaches its prescribed upper limit threshold, as for example, shown in the plot of FIG. 16.

In the above charging process, the described fast-charging protocol comprises passing a high-frequency current through the battery while performing fast-charging. Then if the battery temperature gets to a prescribed threshold level, then the high-frequency current is turned off, and the battery is charged at a low rate and if necessary, the charging is stopped until the battery has cooled down the prescribed temperature threshold. As the temperature goes up, the amplitude of high-frequency current may be reduced to reduce heating rate.

It is appreciated by those skilled in the art that the “Adapter-based Fast-Charger System” embodiment 103 of FIG. 27 may also operate in a slow charging mode, i.e., well below the charging rate of 1C, for example at a rate of 0.2C, when charging time is not an issue, for example when the battery is to be charged overnight. In such slow charging modes, the “Battery Heating Mode” is also used when the battery temperature is below its optimal charging temperature, to bring the charged battery temperature to its optimal operating temperature at the prescribed time for the user, and to minimize battery life reduction by charging the battery at its optimal charging temperature. In addition, the “Battery Heater/Ionic-Exciter” may also be used in its “Battery Ionic-Excitation Mode” to reduce/eliminate any potential plating damage to the battery.

It is appreciated that as it was indicated previously, the applied high-frequency current allows for battery charging at high-rates that may be over 2C-3C at lower temperatures without causing damage (plating), such as Lithium plating in Li-ion batteries.

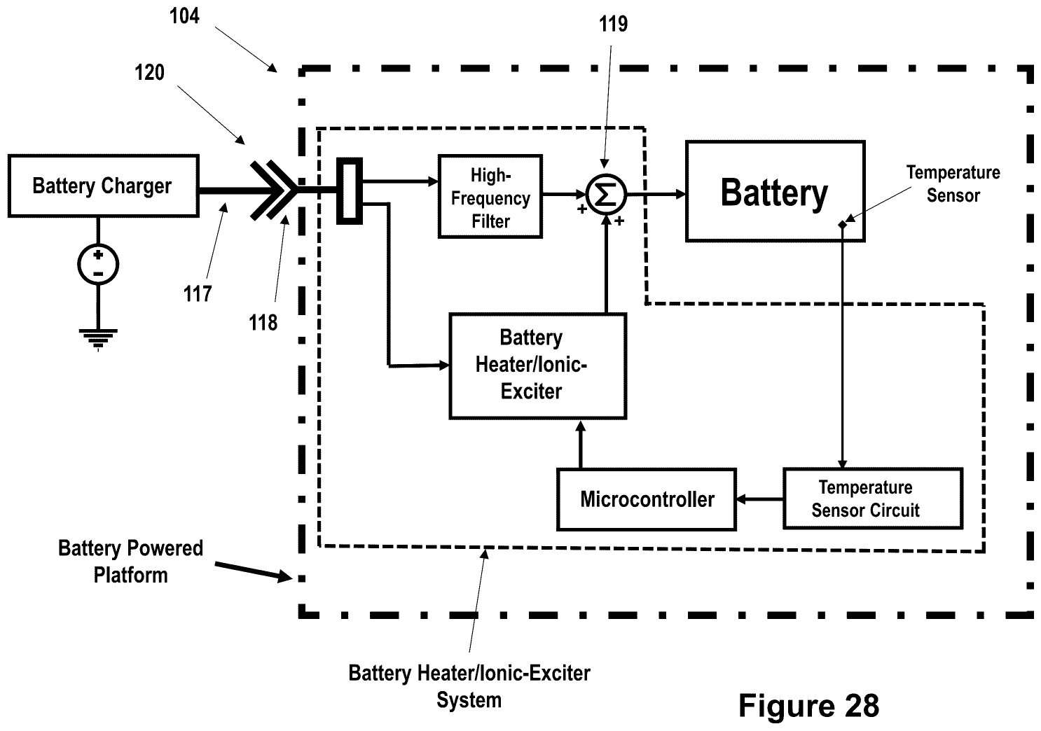

It is appreciated that in certain applications, such as in electric vehicles, trucks, various mobile and fixed platforms, and the like, hereinafter referred to collectively as the “Battery Powered Platforms”, it is highly desirable to have the disclosed high-frequency direct battery electrolyte heating capability be incorporated into these platforms so that their batteries could be charged at any desired rate, including fast rates, using available chargers. To this end, the “Battery Heater/Ionic Exciter” unit, FIGS. 26 and 26, and its related components are positioned inside the intended “Battery Powered Platforms” as shown in the block diagram of FIG. 28. The resulting charging system, hereinafter referred to as the “Platform Integrated Fast-Charging System”, is indicated as embodiment 104.

In the block diagram of FIG. 28, the “Platform Integrated Fast-Charging System” embodiment 104 is shown inside the “Battery Powered Platform”, such as an electric powered vehicle, truck, other mobile or fixed platforms, and the like, which is shown by the enclosing dash-dot enclosing lines. The “Platform Integrated Fast-Charging System” can be seen to comprise the “Battery Heater/Ionic-Exciter System”, which is enclosed by dashed lines. The battery (battery pack) is also shown inside the “Battery Powered Platform”. In this system, the “Battery Charger” is powered by an external source, FIG. 28, and is provided with an output cable 117 with a multi-conductor connector for connection to the mating connector 118 of the “Battery Powered Platform”.

As can be seen in the block diagram of FIG. 28, the “Battery Heater/Ionic-Exciter System” comprises the previously described “Battery Heater/Ionic-Exciter” unit, FIGS. 25 and 26, and related microcontroller. In addition, depending on the type of temperature sensor used for measuring the battery temperature, an appropriate “Temperature Sensor Circuit” might have to be provided to input the measured temperature level to the microcontroller. The “Battery Heater/Ionic-Exciter” unit is also powered by the DC current provided by the “Battery Charger” via the multi-conductor connector 120 with mating parts 117 and 118.

It is appreciated by those skilled in the art that since most currently used battery chargers are not generally designed to filter high-frequency currents from passing into its internal circuits, a “High-Frequency Filter” is provided in the “Battery Heater/Ionic-Exciter System” before the junction 199, FIG. 28, in which the high-frequency AC current output of the “Battery Heater/Ionic-Exciter” is superimposed over the DC battery charging current of the “Battery Charger” and being supplied to the “Battery”. Such a “High-Frequency Filter” is generally required in the present configured system of FIG. 28 to prevent high-frequency current generated by the “Battery Heater/Ionic Exciter System” from interfering with the operation of the “Battery Charger” electronics. Such “High-Frequency Filter” elements are well known in the art and are used in many similar applications and usually comprises a properly sized inductor element to lower the amplitude of the input high-frequency current to an acceptable level for the operation of the related devices, in this case the electronics of the “Battery Charger”.

It is appreciated by those skilled in the art that in general, the connector 120 needs to be of multi-connector type to allow input from the battery temperature sensor to be provided to both the “Battery Charger” and the “Battery Heater/Ionic Exciter” unit controls and to connect all other existing “Battery” electronic and electrical sensory and control wirings, such as “Battery Management System” (BMS) wirings to the “Battery Charger” and the “Battery Heater/Ionic-Exciter” units.

An environmental temperature sensor (not shown), which may be positioned inside the “Battery Heater/Ionic-Exciter System”, FIG. 28, is also usually provided and is used by the “Battery Heater/Ionic-Exciter System” for their proper operation as was previously described for the operation of the “Fast-Charger System” embodiment 100 of FIG. 25.

It is appreciated by those skilled in the art that as it was previously described for the “Fast-Charger System” embodiment 100 of FIG. 25, in the “Platform Integrated Fast-Charging System” embodiment 104 of FIG. 28, the operation of the “Battery Heater/Ionic-Exciter” component in both its modes, i.e., in its “Battery Heating Mode” and “Battery Ionic-Excitation Mode” would result in the battery electrolyte heating and generate ionic-excitation, in which the latter is the main source of battery electrolyte heating as was previously described. However, as it was previously described for the embodiments of FIGS. 25 and 26, in the “Battery Heating Mode”, the heating rate of the battery electrolyte is maximized, while in the “Battery Ionic-Excitation Mode”, the battery electrolyte heating rate is attempted to be minimized.

This means that in the “Platform Integrated Fast-Charging System” embodiment 104, similar to the embodiment 100 and 101 of FIGS. 25 and 26, respectively, the current frequency of the “Battery Heater/Ionic-Exciter” member is programmed to operate in its “Battery Heating Mode” when it is needed for battery electrolyte heating, in which case the current frequency is set at or close to its maximum heating rate. Then when the primary purpose of the applied high-frequency current is to generate “ionic-excitation” of the electrolyte ions, the “Battery Heater/Ionic-Exciter” is set to its “Battery Ionic-Excitation Mode”, in which the current frequency is generally set significantly above or below its maximum heating rate to reduce battery heating rate while increasing ionic excitation in the battery electrolyte, thereby as was previously indicated, prevent damage to the battery by plating (e.g., Lᵢ plating in Li-ion batteries) with the application of high charging currents, such as 2C-3C or even higher.

The operation of the “Platform Integrated Fast-Charging System” embodiment 104 of FIG. 28 is also controlled by the provided, generally programmable, “Battery Charger” control unit, and the programmable microcontroller of the “Batter Heater/Ionic-Exciter System”, FIG. 28. The temperature of the battery is measured by the provided temperature sensor, such as a well-known thermocouple or thermistor or the like, the output of which is provided to the microcontroller of the “Batter Heater/Ionic-Exciter System”. A temperature sensor is also provided (not shown), such as in the “Battery Heater/Ionic-Exciter System” as was previously indicated for measuring environmental temperature of the battery and provide the information to the “Battery Heater/Ionic-Exciter System” microcontroller for setting an optimal process for the required battery charging and heating as described previously described for the embodiment 101 of FIG. 26. The “Control Panel” (not shown) of the “Battery Charger” would provide the means for the user to turn it on and off and select its operational parameters. The operational parameters of the “Battery Heater/Ionic-Exciter” unit are usually set by the platform and/or the “Battery” and/or the battery control electronic (e.g., BMS for Li-ion and the like batteries) manufacturer.

The “Platform Integrated Fast-Charging System” embodiment 104 of FIG. 28 operates as follows. When the system is turned on for the first time, the user will use the provided system means described below, to set the system parameters and select the provided operational options for the “Battery Charger” and for the “Battery Heater/Ionic Exciter System” if they are not set by the manufacturer, but certain charging and heating options may be provided for the user to select. For the “Battery Charger”, the parameters to be provided include the battery type, size, and all other pertinent characteristic information; heating temperature threshold and its acceptable range; acceptable heating and charging rate ranges; the desired charging rate according to the time of day and weekdays; etc. It is appreciated that many or even all these parameters and options for the “Battery Charger” may be set by the equipment manufacturer or seller, particularly if it is purchased together with the equipment in which the battery is installed. In some applications, the system may be provided with a limited number of set of parameters preset options, for example for overnight charging and keeping or bringing the battery at its optimal temperature and fully charged by certain time in the morning for optimal operational performance and to maximize the battery life.

It is also appreciated by those skilled in the art that the above methods and means to input the required and desired charging and heating parameters and operational options (i.e., initializing the system) are well known in the art. Other well-known methods, such as factory setting of all the parameters and options for the user and providing minimal user input, usually buttons and/or switches, for the user interaction with the “Battery Charger” and for the “Battery Heater/Ionic Exciter System”, such as on/off switch, emergency shut-down button, “Battery Heater/Ionic-Exciter” on/off switches, etc., may also be provided.

Once the “Platform Integrated Fast-Charging System” embodiment 104 of FIG. 28 is initiated by setting all the required parameters and options as is described above, the user can engage the multi-conductor connector 120 and turn the “Battery Charger” on. Once the system is turned on, the software driven “Battery Charger” and the “Battery Heater/Ionic Exciter System” microcontrollers collects data as to the battery and battery environment temperatures and charge the battery as it was previously described for the embodiment 101 of FIG. 26. The “Platform Integrated Fast-Charging System” controls can also be programmed to determine the optimal battery charging rate depending on the prescribed amount of time available for the battery to be fully (or partially) charged.

In the above charging process, the described fast-charging protocol comprises passing a high-frequency current through the battery while performing fast-charging. Then if the battery temperature gets to a prescribed threshold level, then the high-frequency current is turned off, and the battery is charged at a low rate and if necessary, the charging is stopped until the battery has cooled down the prescribed temperature threshold. As the temperature goes up, the amplitude of high-frequency current may be reduced to reduce heating rate.

It is appreciated by those skilled in the art that the “Platform Integrated Fast-Charging System” embodiment 104 of FIG. 28 may also operate in a slow charging mode, i.e., well below the charging rate of 1C, for example at a rate of 0.2C, when charging time is not an issue, for example when the battery is to be charged overnight. In such slow charging modes, the “Battery Heating Mode” is also used when the battery temperature is below its optimal charging temperature, to bring the charged battery temperature to its optimal operating temperature at the prescribed time for the user, and to minimize battery life reduction by charging the battery at its optimal charging temperature. In addition, the “Battery Heater/Ionic-Exciter” may also be used in its “Battery Ionic-Excitation Mode” to reduce/eliminate any potential plating damage to the battery.

It is appreciated that as it was indicated previously, the applied high-frequency current allows for battery charging at high-rates that may be over 2C-3C at lower temperatures without causing damage (plating), such as Lithium plating in Li-ion batteries.

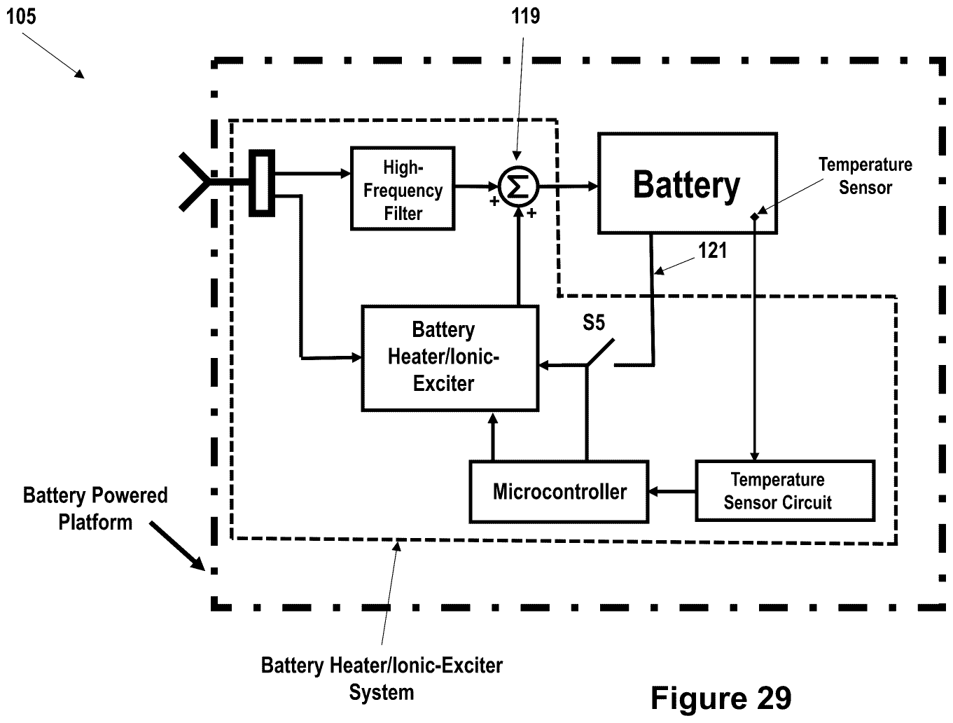

It is appreciated that in certain applications, such as in electric vehicles, trucks, various mobile and fixed platforms, and the like, i.e., the aforementioned “Battery Powered Platforms”, it is highly desirable to have the “Platform Integrated Fast-Charging System” embodiment 104 of FIG. 28 be provided with the capability of keeping the “Battery” at or close to its optimum operating temperature once the “Battery” is charged to the prescribed level and the “Battery Charger” has been disconnected from the “Battery Powered Platform”. To this end, “Platform Integrated Fast-Charging System” embodiment 104 of FIG. 28 can be modified as shown in the block diagram of FIG. 29, identified as embodiment 105, to provide this capability as described below.

In the modified “Platform Integrated Fast-Charging System” embodiment 105 of FIG. 29, the “Battery Heater/Ionic-Exciter” unit and the system microcontroller are powered by the battery via the line 121 and through the on/off switch S5. All other components of the modified “Platform Integrated Fast-Charging System” embodiment 105 are identical to those of the “Platform Integrated Fast-Charging System” embodiment 104 of FIG. 28. The “Battery Heater/Ionic-Exciter” unit may be provided with two high-frequency current generating circuits; one of the types shown in the block diagram of FIG. 13A and circuit of FIG. 13, and the other of the type shown in the circuit of FIG. 14.

Alternatively, particularly if a relatively low battery electrolyte heating rates are required, for example, when the charging rate does not have to be high and/or the environmental temperature is not very low or the “Battery” is provided with a very effective thermal insulation, then the “Battery Heater/Ionic-Exciter” unit may be provided with only the heating circuit of the type shown in FIG. 14, which would then be powered by the “Battery Charger” when the “Battery” is being charged and by the “Battery” itself when the battery is not being charged.

In the modified “Platform Integrated Fast-Charging System” embodiment 105 of FIG. 29, similar to the embodiment 100 and 101 of FIGS. 25 and 26, respectively, the current frequency of the “Battery Heater/Ionic-Exciter” member is programmed to operate in its “Battery Heating Mode” when it is needed for battery electrolyte heating, in which case the current frequency is set at or close to its maximum heating rate. Then when the primary purpose of the applied high-frequency current is to generate “ionic-excitation” of the electrolyte ions, the “Battery Heater/Ionic-Exciter” is set to its “Battery Ionic-Excitation Mode”, in which the current frequency is generally set significantly above or below its maximum heating rate to reduce battery heating rate while increasing ionic excitation in the battery electrolyte, thereby as was previously indicated, prevent damage to the battery by plating (e.g., Lᵢ plating in Li-ion batteries) with the application of high charging currents, such as 2C-3C or even higher.

The operation of the modified “Platform Integrated Fast-Charging System” embodiment 105 of FIG. 29 is also controlled by the provided, generally programmable, “Battery Charger” control unit, and the programmable microcontroller of the “Batter Heater/Ionic-Exciter System”, FIG. 29. The temperature of the battery is measured by the provided temperature sensor, such as a well-known thermocouple or thermistor or the like, the output of which is provided to the microcontroller of the “Batter Heater/Ionic-Exciter System”. A temperature sensor is also provided (not shown), such as in the “Battery Heater/Ionic-Exciter System” as was previously indicated for measuring environmental temperature of the battery and provide the information to the “Battery Heater/Ionic-Exciter System” microcontroller for setting an optimal process for the required battery charging and heating as described previously described for the embodiment 101 of FIG. 26. The operational parameters of the “Battery Heater/Ionic-Exciter” unit are usually set by the platform and/or the “Battery” and/or the battery control electronic (e.g., BMS for Li-ion and the like batteries) manufacturer.

The modified “Platform Integrated Fast-Charging System” embodiment 105 of FIG. 29 operates as follows. When the system is turned on for the first time, the user will use the provided system means described below, to set the system parameters and select the provided operational options for the “Battery Charger” and for the “Battery Heater/Ionic Exciter System” if they are not set by the manufacturer, but certain charging and heating options may be provided for the user to select. For the “Battery Charger”, the parameters to be provided include the battery type, size, and all other pertinent characteristic information; heating temperature threshold and its acceptable range; acceptable heating and charging rate ranges; the desired charging rate according to the time of day and weekdays; etc. In some applications, the system may be provided with a limited number of set of parameters preset options, for example for overnight charging and keeping or bringing the battery at its optimal temperature and fully charged by certain time in the morning for optimal operational performance and to maximize the battery life.

It is also appreciated by those skilled in the art that the above methods and means to input the required and desired charging and heating parameters and operational options (i.e., initializing the system) are well known in the art. Other well-known methods, such as factory setting of all the parameters and options for the user and providing minimal user input, usually buttons and/or switches, for the user interaction with the “Battery Charger” and for the “Battery Heater/Ionic Exciter System”, such as on/off switch, emergency shut-down button, “Battery Heater/Ionic-Exciter” on/off switches, etc., may also be provided.

Once the modified “Platform Integrated Fast-Charging System” embodiment 105 is initiated (or it has been initiated with the “Battery Charger” configuration of FIG. 28), then when the “Battery Charger” is disconnected from the platform by disconnecting the multi-contact connector 120, FIG. 28, and if the platform connected “Battery Charger” is turned off, then the switch S5, FIG. 29, is closed by the command received from the microcontroller and the “Battery Heater/Ionic-Exciter” is powered by the battery via the line 121 and is set to its “Battery Heating Mode”. Then the “Battery Heater/Ionic Exciter System” microcontrollers collects data as to the battery and battery environment temperatures and begin to heat the battery electrolyte if the battery temperature is below its prescribed low temperature threshold until the battery temperature reaches it upper temperature threshold, at which point, the microcontroller would terminate battery heating. As a result, the battery temperature is kept within a prescribed temperature range.

It is appreciated by those skilled in the art that as it is customary in all battery powered equipment, the microcontroller, FIG. 29, would be programmed to monitor the battery state of charge, and if it falls below a prescribed threshold, it would terminate the above temperature maintenance process, i.e., it would terminate the above battery electrolyte heating process and allow the battery temperature to drop below its prescribed low limit. This feature is usually required to protect the battery from low charge level damage or due to certain operational requirements of the platform.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated but should be constructed to cover all modifications that may fall within the scope of the appended claims.

What is claimed is:

1. A charging and high-frequency current heating device for charging and temperature maintenance of an energy storage device when coupled to the energy storage device, the energy storage device having a core with an electrolyte having ions therein, and having inputs, with one of the inputs having characteristics of a frequency-dependent resistor and inductor series coupled to a voltage source, the device comprising:
an energy storage device coupling configured to be coupled to the one input of the energy storage device;
a heater/ionic exciter coupled to the energy storage device coupling, wherein the battery heater/ionic exciter is configured to provide a positive input current and a negative input current at the one input when coupled to the one input through the energy storage device coupling, wherein the battery heater/ionic exciter is configured to operate including in at least one of two modes wherein a first one of the two modes is a heating mode in which a current frequency is set at or close to a maximum heating rate to provide alternating positive and negative input currents at a high-frequency configured to substantially maximize an internal heating effect of the ions within the electrolyte of the energy storage device to generate heat and raise a temperature of the electrolyte, and a second one of the two modes is a primarily an ionic-excitation mode in which the current frequency is set above the maximum heating rate to generate ionic-excitation of the electrolyte ions;
a device input configured to be coupled to an energy storage device charger;
a switch, configured to be coupled between the device input and the energy storage device coupling; and
a controller configured to control the battery heater/ionic exciter to provide switching on and off of the two modes and to control switching of the switch.

2. The device of claim 1, wherein the controller is configured to control the heater/ionic exciter to discontinue the first mode when the temperature of the electrolyte and/or the energy storage device is within an operational temperature range of the energy storage device.

3. The device of claim 1, wherein the controller is configured to control the heater/ionic exciter to operate in the first mode when the temperature of the electrolyte and/or the energy storage device is below an operational temperature range of the energy storage device.

4. The device of claim 1, wherein the controller is configured to control the heater/ionic exciter to operate in the second mode when the temperature of the electrolyte and/or the energy storage device is within an operational temperature range of the energy storage device.

5. The device of claim 1, wherein the controller is configured to control the heater/ionic exciter to operate in the second mode when the temperature of the electrolyte and/or the energy storage device is within an operational temperature range of the energy storage device and is configured to control the heater/ionic exciter to discontinue the second mode when the temperature of the electrolyte and/or the energy storage device is above the operational temperature range of the energy storage device.

6. The device of claim 1, comprising a high frequency filter coupled between the device input and the energy storage device coupling, wherein the high frequency filter is configured to filter the high-frequency alternating positive and negative input currents.

7. The device of claim 1, wherein the processor is configured to set parameters of the first and second modes based on an identification of a composition of the energy storage device and a duration available for charging.

8. The device of claim 1, wherein the processor is configured to switch on both of the first and second modes to perform charging that is faster than when only the second mode is switched on.

9. The device of claim 1, wherein the heater/ionic exciter is configured to provide both of the first and second modes from power provided by the energy storage device when coupled to the energy storage device.

10. The device of claim 1, wherein the heater/ionic exciter is configured to provide both of the first and second modes from an external power supply when coupled to the external power supply.

11. A fast-charging system, the system comprising the device of claim 1, further comprising a battery charger, the battery charger being coupled to the device input.

12. The system of claim 11, comprising a high frequency filter coupled between the device input and the energy storage device coupling, wherein the high frequency filter is configured to filter the high-frequency alternating positive and negative input currents.

13. The system of claim 11, comprising a temperature sensor circuit coupled to the processor, wherein the temperature sensor circuit is configured to receive indications of a temperature of the electrolyte, the energy storage device and/or an ambient temperature and is configured to provide the indications to the processor, wherein the processor is configured to provide the switching of the two modes and the switching of the switch in response to the received indications.

14. The system of claim 11, comprising an energy storage device charger coupled to the device input.

15. The system of claim 14, comprising a high frequency filter coupled between the device input and the energy storage device coupling, wherein the high frequency filter is configured to filter the high-frequency alternating positive and negative input currents.

16. The system of claim 15, comprising a summing circuit, the summing circuit comprising a first summing input, a second summing input and a summing output, the first summing input being coupled to an output of the high frequency filter, the second summing input being coupled to an output of the heater/ionic exciter and the summing output being coupled to the energy storage device coupling.

17. The system of claim 16, comprising a temperature sensor circuit coupled to the processor, wherein the temperature sensor circuit is configured to receive indications of a temperature of the electrolyte, the energy storage device and/or an ambient temperature and is configured to provide the indications to the processor, wherein the processor is configured to provide the switching of the two modes and the switching of the switch in response to the received indications.

18. The system of claim 11, wherein the heater/ionic exciter is configured to provide both of the first and second modes from power provided by the energy storage device when coupled to the energy storage device.

19. The system of claim 11, wherein the heater/ionic exciter is configured to provide both of the first and second modes from an external power supply when coupled to the external power supply.
